(19) United States
(12) Patent Application Publication
(10) Pub. No.: US 2003/0048203 A1
(43) Pub. Date: Mar. 13, 2003

(54) Flight management annunciator panel and system

(76) Inventors: David E. Clary, Bloomington, MN (US); Robert Batholomew, Maple Grove, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/200,085

(22) Filed: Jul. 18, 2002

Related U.S. Application Data
(60) Provisional application No. 60/306,632, filed on Jul. 19, 2001.

(51) Int. Cl. G08B 21/00

(52) U.S. Cl. 340/945; 340/963; 340/438; 340/691.3

(57) ABSTRACT

Potentially hazardous conditions encountered by an aircraft are signaled to the flight crew of the aircraft by a system of visible and audible annunciators. A first visible annunciator indicates cautions and warnings and a second visible annunciator indicates system classifications for detected conditions. The second visible annunciator indicates, for example, a threatened stall, a low fuel condition or excessive airspeed. An audible voice message played over the aircraft communication system is tailored to the potential hazard condition. A user operable button provides condition-specific cancellation authority.

### RELARED APPLICATION

This application claims priority to U.S. Provisional Application serial number 60/306,632 (entitled FLIGHT MANAGEMENT ANNUNCIATOR PANEL AND SYSTEM, filed Jul. 19, 2001) which is herein incorporated by reference.

### TECHNICAL FIELD

This invention relates generally to flight management systems and particularly, but not by way of limitation, to a flight management system and methods for general aviation aircraft.

### BACKGROUND

Flight safety is an important consideration for pilots of general aviation aircraft. In addition to safely operating the airplane and maintaining a desired course, pilots are also tasked with monitoring the data presented by the various cockpit instruments. This data can show, for example, that the fuel level remaining in a particular tank is approaching a dangerous state. During solo flight operations in congested airspace under instrument flight conditions, the general aviation pilot is sometimes overburdened with monitoring the various instruments in the typical aircraft.

What is needed is a system and method that can be installed in new aircraft or retrofitted to existing aircraft that provides the pilot with early notification of a potential problem.

### SUMMARY

Signals from a plurality of sensors distributed throughout the aircraft are analyzed by an on-board processor. The processor drives a visual warning display and produces an audible message. The visual warning display includes a first part and a second part. The first part visually annunciates the condition and includes a user operable switch. The second part provides specific system information as to the nature of the condition and is installed in view of the pilot. The pilot can cancel the audible message using an annunciator switch on the first part. For certain warning conditions, activation of the annunciator switch will extinguish the visual warning display message appearing on the second part.

Set points for alerts triggered by the various sensors are determined by calibration routines executed at the time of configuring the system and determined by aircraft performance data. In one embodiment, a portable computer can be coupled to the present system by an interface connection. The portable computer, which may be a laptop computer, can be used to access stored data, upload programming to the on-board processor, or manage the calibration or operation of the present system. The set points for selected conditions can be adjusted dynamically based on measured parameters.

An existing aircraft can be retrofitted with the present subject matter without disturbing the type certification issued by the Federal Aviation Administration or other governing body. In addition, the present subject matter can be incorporated in the production of new aircraft and certificated as a package.

The present subject matter provides the pilot with status and warning information from several aircraft systems and the cabin environment. Status and warning annunciations provided by the present subject matter are advisory only and shall be treated as secondary to the primary aircraft indication systems. The present system is designed to mimic the indications given by those systems. The present subject matter can adapt to a variety of aircraft having different bus voltages and transducer output levels.

Conditions and parameters monitored by the present system include those that may be potentially hazardous. In one embodiment, a first visible annunciator indicates cautions and warnings and a second visible annunciator indicates system classifications for detected conditions. For example, system notification may include fuel system, cabin integrity, landing gear system, electrical system, navigation system, flight-related systems such as airspeed, stall speed or other systems. The second visible annunciator indicates, for instance, a threatened stall, a low fuel condition or excessive airspeed. An audible voice message, which may be synthesized or recorded voice, is played over the aircraft communication system and is tailored to the potential hazard condition. A user operable button provides condition-specific cancellation authority.

This summary is intended to provide a brief overview of some of the embodiments of the present system, and is not intended in an exclusive or exhaustive sense, and the scope of the invention is to be determined by the attached claims and their equivalents.

### BRIEF DESCRIPTION OF THE DRAWINGS

In the drawings, like numerals describe substantially similar components throughout the several views. Like numerals having different letter suffixes represent different instances of substantially similar components.

FIG. 1A is a drawing illustrating selected portions of a flight management system.

FIG. 1B is a block diagram illustrating an acknowledge switch module.

FIG. 2 is a schematic illustrating generally one embodiment of a processor coupled to selected devices and systems.

FIG. 3 illustrates a processor coupled to various sensors of a flight management system.

FIG. 4A illustrates a fuel gauge coupled to a processor according to one embodiment of the present subject matter.

FIG. 4B illustrates an oil temperature gauge coupled to a processor according to one embodiment of the present subject matter.

FIG. 5A illustrates a schematic for monitoring current in a fuel pump circuit.

FIG. 5B illustrates a schematic for monitoring current in a pitot heater circuit.

FIG. 6 illustrates a model of an oil temperature gauge circuit.

FIG. 7 illustrates a graph of oil temperature sensor voltage as a function of indicated temperature for different aircraft bus voltages.

FIGS. 8A, 8B, 8C and 8D illustrate connections to various aircraft instruments according to one embodiment of the present subject matter.

FIG. 9 illustrates a flow chart for receiving information from the acknowledge switch.

FIG. 10 illustrates a flow chart for receiving pilot selections using the display module switch.

FIG. 11 illustrates a flow chart for a method based on actuation of the acknowledge switch in a caution mode.

FIG. 12 illustrates a flow chart for a method based on actuation of the acknowledge switch in a warning mode.

FIG. 13 illustrates a flow chart for a method based on monitoring the pitot heat sensor.

FIG. 14 illustrates a flow chart for a method based on monitoring the fuel pump sensor.

FIG. 15 illustrates a flow chart for a method based on the stall warning vane switch.

FIG. 16 illustrates a flow chart for a method based on detecting a threatened accelerated stall.

FIGS. 17A and 17B illustrate flow charts for a method based on alerting for a waypoint.

FIGS. 18A and 18B illustrate flow charts for methods based on fuel quantity indications.

FIG. 19 illustrates a flow chart for a method based on remaining fuel in a tank.

FIG. 20 illustrates a flow chart for a method based on a measured oil temperature.

FIG. 21 illustrates a flow chart for a method based on carbon monoxide levels detected in the aircraft cabin.

FIG. 22 illustrates a flow chart for a method based on detected oil pressure levels.

FIG. 23 illustrates a flow chart for a method based on detected oil pressure levels and vacuum levels.

FIG. 24 illustrates a flow chart for a method based on landing gear position sensor switches.

FIG. 25 illustrates a flow chart for a method based on landing gear position sensor switches.

FIG. 26 illustrates a flow chart for a method based on aircraft bus voltages.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents. In the drawings, like numerals describe substantially similar components throughout the several views. Like numerals having different letter suffixes represent different instances of substantially similar components.

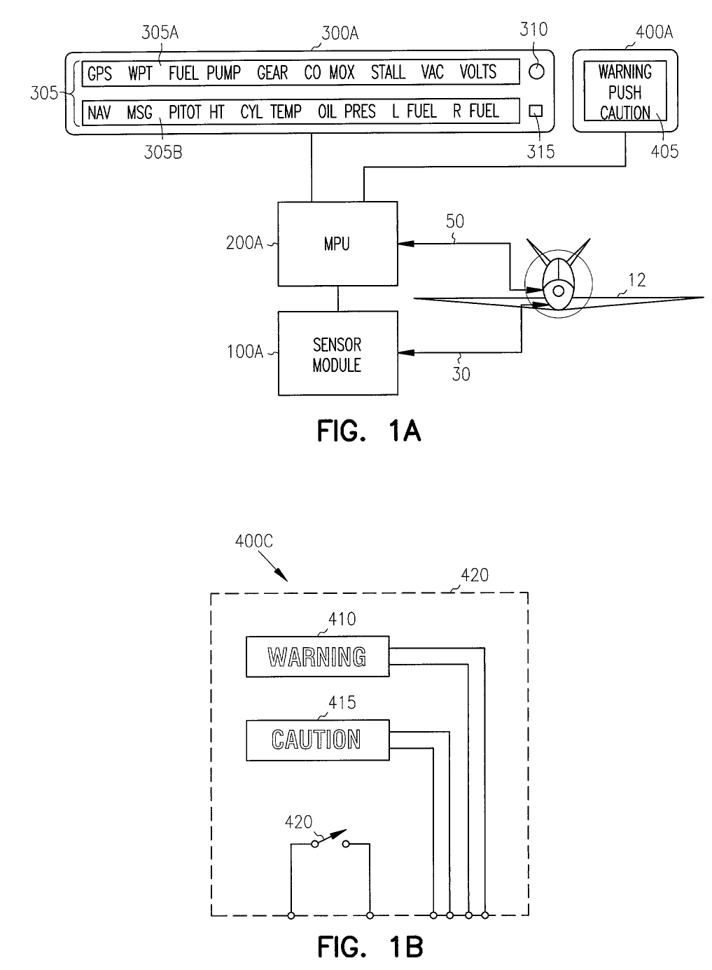

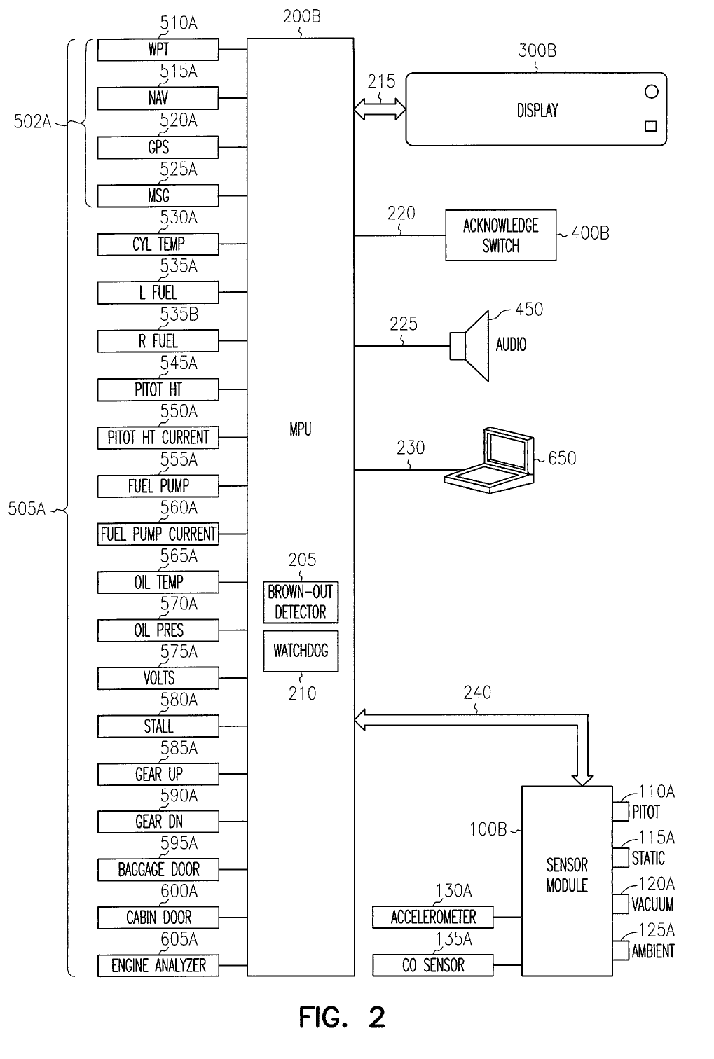

FIG. 1A illustrates a flight management system according to one embodiment of the present subject matter. In this example, the system is coupled to, and installed in, general aviation aircraft 12. Aircraft 12 is powered by a single engine. Display module 300A and acknowledge switch module 400A are installed within the cockpit of aircraft 12. Sensor module 100 is installed in the cabin environment of aircraft 12 and main processor unit 200A is installed on the airframe of aircraft 12. Main processor unit (MPU) 200A is coupled to display module 300A, acknowledge switch module 400A and sensor module 100A by digital data lines. In addition, selected electrical sensors and switches of aircraft 12 are coupled to MPU 200A by signal lines 50. Sensor module 100A includes one or more pressure transducers coupled to selected aircraft systems by air pressure sense, or pneumatic, lines. Sensor module 100A also includes an accelerometer adapted to provide an electrical signal based on acceleration of aircraft 12. In one embodiment, MPU 200A includes a main processor, an input board and a voice board.

Display 300A includes visual display 305, light sensor 310 and mute switch 315. Visual display 305 includes an array of light emitting diodes (LEDs) arranged in an upper line 305A and a lower line 305B adapted to illuminate one or more warning or caution messages. Displayable messages include “GPS,” “WPT,” “FUEL PUMP,” “GEAR,” “CO MOX,” “STALL,” “VAC” and “VOLTS” in upper line 305A and “NAV,” “MSG,” “PITOT HT,” “CYL TEMP,” “OIL PRES,” “L FUEL” and “R FUEL” in lower line 305B. Messages appearing in display 305 are selected for illumination based on signals received from MPU 200A and correspond to sensed conditions, cautions, alerts or warnings. Zero messages, one message or multiple messages may be displayed simultaneously by display 300A.

The light intensity of display module 300A and acknowledge switch module 400A is adjustable. Light sensor 310, disposed on the face of display module 300A, senses the ambient light and generates a signal received by MPU 200A. Main processor unit 200A executes a program to adjust the light intensity of both display module 300A and acknowledge switch module 400A based on the signal from light sensor 310.

Mute switch 315, disposed on the face of display module 300A, is a user accessible, momentary contact, push button switch. Switch 315 controls muting of the voice annunciation, controls playback of previously muted and stored alert messages, controls playback of active alert messages, cautions or conditions and controls execution of rebooting and self-testing. After muting, when switch 315 is again pressed, all previously muted and stored alert messages that remain active are presented via audio 450 in the order of detection.

Acknowledge switch module 400A includes a two-message display and a user operable push button switch. The two-message display allows selective illumination of a first message such as “WARNING” and a second message such as “CAUTION.” Zero messages, one message or two messages may be displayed simultaneously by acknowledge switch module 400A. The legend “PUSH” appears in the center of acknowledge switch module 400A.

In one embodiment, acknowledge switch module 400A is of a shape and size conducive to mounting in, or near, the pilot's instrument scan of aircraft 12. Display module 300A is mounted in a location readily viewable by the pilot. For example, in one embodiment, acknowledge switch 400A is mounted immediately in front of the pilot near the artificial horizon and display module 300A is mounted in the instrument panel above the radio stack.

FIG. 1B illustrates a model of acknowledge switch module 400C according to one embodiment of the present subject matter. Acknowledge switch module 400C includes warning light 410, caution light 415 and switch 420 mounted in housing 420. Electrical connections to warning light 410, caution light 415 and switch 420 are provided by a connector.

When caution light 415 is illuminated, the pilot is instructed to take one of two actions. The pilot acknowledges the cautionary alert by hitting switch 400 once. By depressing switch 420 a single time, caution light 415 is extinguished and a five minute caution reminder timer is started. If the alert condition corresponding to the caution alert remains active at the completion of the timer duration, caution light 415 will again be illuminated as a reminder alert. If the pilot double clicks switch 420, caution light 415 will be extinguished and will remain extinguished unless the alert condition is repeated or another input illuminates caution light 415. Double clicking switch 420 suspends the caution reminder timer.

Warning light 410 an not be manually extinguished. Warning light 410 remains illuminated as long as the warning condition exists.

Acknowledge switch 400C provides volume control for audio 450. If the pilot depresses switch 420 for a period of approximately 3 seconds, audio 450 will annunciate “volume.” The pilot is instructed to depress and release the switch, which will cycle the volume settings from a level of 0 (volume off) to 7 (maximum volume). Audio 450 announces the volume level as it is being changed.

Acknowledge switch 400C provides access to a training mode. If the pilot depresses switch 420 for a period of approximately 5 seconds, audio 450 will annunciate “training mode.” In the training mode, toggling switch 420 will toggle between training mode on and training mode off. Audio 450 announces the training mode state as it is changed. When training mode is on, the voice annunciations for stall warning, accelerated stall, gear up, gear down, and check gear down are muted and the gear and stall lights function normally. The system will revert to normal operation at the next power up.

Acknowledge switch 400C provides access the software version for various elements. If the pilot depresses switch 420 for a period of approximately 7 seconds, audio 450 will annunciate “software version number” followed by a verbal announcement of the version number for MPU 200B, display module 300B and sensor module 100B.

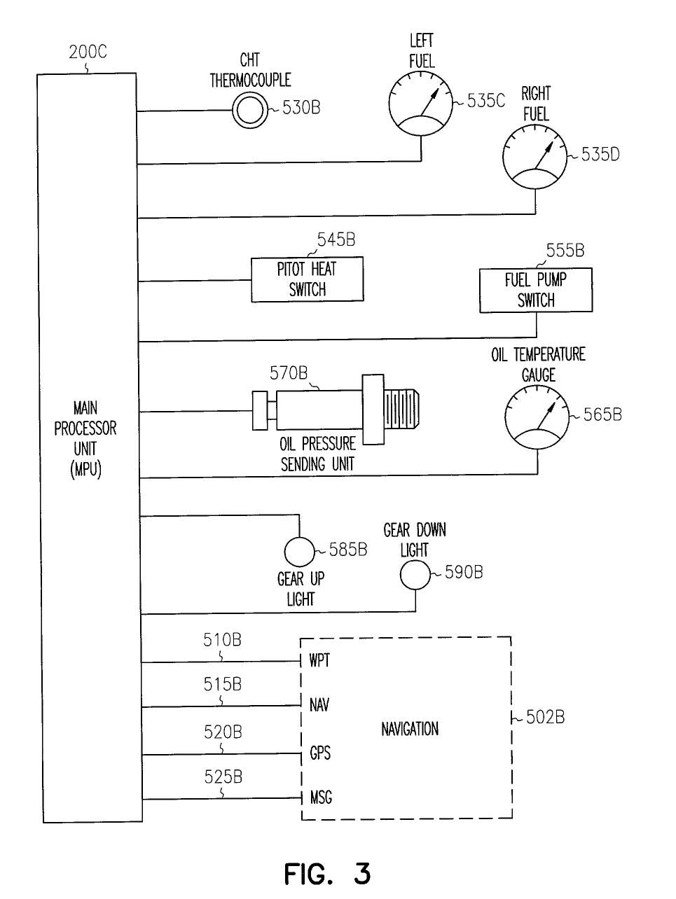

FIG. 2 schematically illustrates a block diagram of one embodiment of the present subject matter. In the figure, MPU 200B is coupled to a first group of input signals, collectively referred to herein as 505A, each of which provides a digital signal. Main processor unit 200B is also coupled to a second group of input signals via sensor module 100B. In addition, MPU 200B is coupled to display 300B, acknowledge switch 400B, audio 450 and computer 650.

Main processor unit 200B includes brown out detector 205 and watchdog 210. Brown out detector 205 operates by monitoring the 5 v supply to MPU 200B. In one embodiment, if the supply voltage drops to 4.5 volts, then brown out detector 205 will power down the system. Brown out detector 205 continues to monitor the supply voltage to MPU 200B and if the voltage rises to a predetermined level, then a re-boot operation is executed. Software executing on MPU 200B generates a pulse every 100 milliseconds (mS). If a pulse is missing, then after a delay time period, watchdog 210 triggers a re-boot operation. The delay time period is 4 seconds in one embodiment.

Those inputs to MPU 200B directed to navigation functions are collectively referred to as inputs 502A. Inputs 502A includes waypoint 510, navigation 515A, global positioning system (GPS) 520A and message 525A. Each of inputs 502A receives a digital signal and depending on the signals received, illuminates a segment of display module 300B.

For example, if navigation information is received from a GPS receiver in aircraft 12, then input GPS 520A will be at a digital low level and the message “GPS” will be illuminated in display module 300B in the color green. An audible message is not generated with this indication.

When the navigation information is received from a VORWLOC (very high frequency, VHF, omnidirectional range/localizer) or other non-GPS based navigation instrument, then input NAV 515A will be at a digital low level and the message “NAV” will be illuminated in display module 300B in the color green. As with the GPS message, an audible message is not generated with this indication.

When the navigation information source issues a waypoint alert, then input WPT 510A will be at a digital low level and the message “WPT” will be illuminated in display module 300B in the color green. In addition, MPU 200B causes an audible alert message to be presented. The alert message includes the spoken word “waypoint” played over a headset to be worn by the pilot or played over a cabin speaker. The audible alert message, or voice annunciation, is played via audio 450. Audio 450, in one embodiment, includes an aircraft audio panel.

When the navigation information source issues a message alert, then input MSG 525A will be at a digital low level and the message “MSG” will be illuminated in display module 300B in the color amber. As with the GPS message and the NAV message, an audible message is not generated with this indication.

Input CYL TEMP 530A is coupled to a spark-plug ring J-type thermocouple and provides an electrical signal corresponding to a cylinder head temperature. When the monitored cylinder head temperature is at the maximum temperature operating range, the message “CYL TEMP” will be displayed in display module 300B in the color red. In addition, acknowledge switch 400B illuminates warning light 410 and a voice annunciation alert stating “check cylinder temperature” is presented audibly via audio 450. Audible presentation entails playing the annunciation message via the pilot's headset or a cabin speaker. The set point for the cylinder temperature warning is stored in memory accessible to MPU 200B and is determined by aircraft 12. In one embodiment, a cylinder head temperature high set point is 430° F.

Inputs L FUEL 535A and R FUEL 535B are coupled to fluid level transducers installed in the left and right fuel tanks. Main processor unit 200B receives voltage signals from each transducer. An empty fuel tank is represented by zero volts and the voltage output from a full tank is determined by filling the tank with fuel and storing the output voltage in a memory accessible to MPU 200B. Software executing on MPU 200B calculates and establishes alarm set points at 25% and 10% of the range. When MPU 200B determines that the remaining fuel in any one tank of aircraft 12 corresponds to the 25% set point, caution light 415 is illuminated and display module 300B displays a corresponding message, such as “L FUEL” or “R FUEL,” and MPU 400B generates and presents an audible message such as “right tank at twenty-five percent” or “left tank at twenty-five percent” via audio 450. When MPU 200B determines that the remaining fuel in all tank corresponds to a value at or below the 10% set point, MPU 400B generates and presents an audible message such as “right tank at ten percent” or “left tank at ten percent” via audio 450. When MPU 200B determines that the remaining fuel in all tanks is below the 10% set point, caution light 415 is extinguished and warning light 410 is illuminated.

In one embodiment, the maximum transducer output voltage, corresponding to full tanks) is used to calculate the set points at lower fuel quantities. False fuel level alerts are reduced by storing 1024 transducer voltage samples and taking the average over 100 seconds.

Input PITOT HT CURRENT 550A is coupled to a solid state current monitor. When the aircraft pitot heat switch is in the off position, no current is drawn and the visual and audible annunciators are off. When the pitot heat switch is in the on position, as determined by a line coupled to the pitot heat panel switch and PITOT HT 545A, and current flow to the pitot heater is detected, display module 300B illuminates a message “PITOT HT” in the color green. When the pitot heat switch is in the on position and the current is less than the predetermined set point, then the “PITOT HT” message of display module 300B is extinguished and caution light 415 is illuminated. In addition, a voice annunciation alert “pitot heat failure” is presented via audio 450. In one embodiment, the minimum pitot heat current is 3.00 amperes and the maximum pitot heat current is 1.00 amperes.

Input FUEL PUMP CURRENT 560A is coupled to a solid state current monitor. When the fuel pump switch is in the off position, no current is drawn and the visual and audible annunciators are off. When the fuel pump switch is in the on position, as determined by a line coupled to the fuel pump panel switch and FUEL PUMP 555A, and current flow to the fuel pump is detected display module 300B illuminates a message “FUEL PUMP” in the color green. When the fuel pump switch is in the on position and the current is less than the predetermined set point, then the “FUEL PUMP” message of display module 300B is extinguished and caution light 415 is illuminated. In addition, a voice annunciation alert “fuel pump failure” is presented via audio 450.

Input OIL TEMP 565A is coupled to a thermal sensor exposed to an engine oil galley. The engine oil temperature thermal sensor may include a resistance temperature detector (RTD) probe configured as a plug or bayonet. In one embodiment, the oil temperature thermal sensor is also used to provide an electrical signal for a panel-mounted temperature gauge. When the measured oil temperature is above the maximum temperature set point, a voice annunciation alert “check oil temperature” is presented via audio 450. In addition, warning light 410 is illuminated and the voice annunciation “check oil temperature” repeats every 5 seconds unless switch 420 is activated. Activation of switch 420 will delay or cancel the audio alert from audio 450. The maximum temperature set point is selected based on data provided by the aircraft manufacturer or as determined by the aircraft operators manual and stored in memory accessible to MPU 200B. In one embodiment, the maximum temperature set point for the oil is 225° F.

Input OIL PRES 570A is coupled to pressure transducer exposed to engine oil pressure. When the measured oil pressure is below a minimum oil pressure level, warning light 410 is illuminated and display module 300B illuminates “OIL PRES” in a red color. In addition, a voice annunciation alert “check oil pressure” is presented via audio 450. The minimum oil pressure set point is selected based on data provided by the aircraft manufacturer or as determined by the aircraft operators manual and stored in memory accessible to MPU 200B. In one embodiment, the low oil pressure set point is approximately 30.0 psi.

Input VOLTS 575A is coupled to the aircraft supply bus. When the measured voltage exceeds the high set point, warning light 410 is illuminated and display module 300B illuminates a “VOLTS” message in an amber color. In addition, a voice annunciator alert “bus voltage high” is presented via audio 450. When the measured voltage is below the low set point, caution light 415 is illuminated and display module 300B illuminates the “VOLTS” message in an amber color. In addition, a voice annunciator alert “bus voltage low” is presented via audio 450. The high set point and the low set point are selected based on data provided by the aircraft manufacturer or as determined by the aircraft operators manual and stored in memory accessible to MPU 200B. In one embodiment, the high set point and low set point for the bus voltage is 14.50 and 12.00 volts DC (VDC), respectively.

Input STALL 580A is coupled to a stall vane switch on aircraft 12. In unaccelerated flight, when the vane switch indicates a stall condition, display module 300B illuminates the message “STALL” in a red color and warning light 410 is illuminated. In addition, a voice annunciator alert “stall, stall, stall” is presented via audio 450.

In accelerated flight, accelerometer 130A, coupled to MPU 200B via sensor module 100B senses the g-loading. When the g-loading of the aircraft, as measured by accelerometer 130A, and airspeed of the aircraft, as measured by the airspeed transducer of sensor module 100B, indicates that aircraft 12 is within 5 to 10 knots of an accelerated stall, display module 300B illuminates a “STALL” message in red color and caution light 415 is illuminated. In addition, a voice annunciation alert “check airspeed” is presented via audio 450. In one embodiment, to reduce false alarms resulting from turbulence, a delay period of time is introduced before triggering the visual and audible annunciation. The set point for the accelerated stall is selected based on data provided by the aircraft manufacturer or as determined by the aircraft operators manual and is stored in memory accessible to MPU 200B. In one embodiment, the set point corresponds to the flaps up, maximum weight data. In one embodiment, the accelerated stall speed set point is 60 knots. Programming executing on MPU 200B of the present system determines the accelerated stall speed of the aircraft based on extrapolation, or interpolation, of accelerated stall speed data. Visible and audible annunciation of accelerated stall warning is disabled for airspeeds below 90% of the unaccelerated stall speed (that is, flaps up, maximum weight, straight and level flight).

Table 1 illustrates various accelerated stall speeds as a function of g-loading. An accelerated stall can occur at any bank angle, however, for comparison sake, the table below also shows corresponding bank angles for the listed accelerations. For example, an aircraft with a 40 knot stall speed in straight and level flight will stall at 43 knots when accelerated to 1.15 g, typically encountered in a coordinated turn at a 30 degree bank angle. In a turn at 45 degrees, the same aircraft is experiencing an acceleration of 1.44 g and will stall at 48 knots. In a turn at 60 degrees, the same aircraft is experiencing an acceleration of 2.0 g and will stall at 57 knots. The table also presents stall speeds for other aircraft having unaccelerated stall speeds ranging to 85 knots in 5 knot increments.

TABLE 1

| 1.0 | 1.15 g | 1.44 g | 2.0 g |
|---|---|---|---|
| (0 degrees) | (30 degrees) | (45 degrees) | (60 degrees) |
| 40 | 43 | 48 | 57 |
| 45 | 48.5 | 53 | 63 |
| 50 | 54 | 59 | 70 |
| 55 | 59 | 65.5 | 77 |
| 60 | 64.5 | 72.5 | 85 |
| 65 | 70 | 77 | 92 |
| 70 | 75.5 | 83 | 99 |
| 75 | 80.5 | 89 | 107 |
| 80 | 86 | 95 | 113 |
| 85 | 92 | 101 | 120 |

Input GEAR UP 585A is coupled to the gear up position switch of aircraft 12 and provides an electrical signal when the aircraft landing gear is in the up, or raised, position. Input GEAR DN is coupled to the gear down position switch of aircraft 12 and provides an electrical signal when the aircraft landing gear is in the down position. The GEAR message appearing on display module 300B is in a red color.

A voice annunciation alert stating “check gear” is presented via audio 450, warning light 410 is illuminated, and a “GEAR” message appears on display module 300B if a landing gear in-transit signal is received for a duration more than 20 seconds.

Several methods can be employed to determine when the landing gear is in-transit and one method is selected at the time of installation or calibration. One exemplary method entails monitoring for a time when both gear up and gear down lights are extinguished. One exemplary method entails monitoring illumination of a gear unsafe light. One exemplary method entails monitoring landing gear switches showing that the landing gear is not in a locked position. Other methods are also contemplated.

In addition, a voice annunciation alert stating “check gear” is presented via audio 450, warning light 410 is illuminated, and a “GEAR” message appears on display module 300B if aircraft 12 indicates a gear-down and gear-up condition simultaneously for a duration of more than 6 seconds. Also, a voice annunciation alert stating “check gear” is presented via audio 450, warning light 410 is illuminated and a “GEAR” message appears on display module 300B if both the gear-down and gear-up indicators remain off simultaneously for a duration of more than 20 seconds.

When sensor module 100B signals that the airspeed is below a predetermined set point and the gear position indicator signals that the landing gear is in the up position, warning light 410 is illuminated, display module 300B illuminates the “GEAR” message and a voice annunciation alert “check gear down” will be presented via audio 450. In one embodiment, the gear down set point is 90 knots and speeds below this level with the landing gear in the up position will trigger a warning.

A voice annunciation alert “gear up” will be presented via audio 450 when the landing gear system completes a gear up cycle. A voice annunciation alert “gear down” will be presented via audio 450 when the landing gear system completes a gear down cycle.

If the pilot selects gear down while at an airspeed, as detected by sensor module 100B, above a maximum gear extension speed set point, warning light 410 is illuminated, a “GEAR” message is illuminated on display module 300B and a voice annunciation alert “gear overspeed” will be presented via audio 450. The maximum gear extension speed set point is stored in a memory accessible to MPU 200B. In one embodiment, the maximum gear extension speed set point is 130 knots.

Input BAGGAGE DOOR 595A is coupled to a door switch adapted to indicate an unsafe baggage or utility door position. When the door switch indicates an unsafe position, caution light 415 is illuminated and remains on until switch 420 is manually operated. In addition, a voice annunciation alert “check baggage door” is presented via audio 450. The voice annunciation is repeated on five minute intervals. Pressing switch 420 once extinguishes caution light 415 and starts a timer having a duration of approximately five minutes. At the end of the timer period, caution light 415 is again illuminated. Pressing switch 420 twice extinguishes caution light 415 and terminates the voice annunciation without starting a timer. The baggage door alert will be reset and a subsequent detection of a door switch signal will again trigger a caution light and voice annunciation.

Input CABIN DOOR 600A is coupled to a door switch adapted to indicate an unsafe cabin door position. When the door switch indicates an unsafe position, caution light 415 illuminates and remains on until switch 420 is manually operated. In addition, a voice annunciation alert “check cabin door” is presented via audio 450. The voice annunciation is repeated on five minute intervals. Pressing switch 420 once extinguishes caution light 415 and starts a timer having a duration of approximately five minutes. At the end of the timer period, caution light 415 is again illuminated. Pressing switch 420 twice extinguishes caution light 415 and terminates the voice annunciation without starting a timer. The cabin door alert will be reset and a subsequent detection of a door switch signal will again trigger a caution light and voice annunciation.

Input ENGINE ANALYZER 605A is coupled to an electronic engine analyzer or monitor having a discrete alarm output signal. When an alarm output signal is received, warning light 410 illuminates and remains on until the engine analyzer or monitor cancels the signal. In addition, a voice annunciation alert “check engine analyzer” is presented via audio 450. The voice annunciation is repeated on five minute intervals. Pressing switch 420 twice terminates the voice annunciation without starting a timer.

Programming executing on MPU 200B monitors for airspeeds approaching V_{NE} (velocity, never exceed), as determined by data specified by the aircraft manufacturer. When aircraft 12 is at a speed within 5% of V_{NE}, warning light 410 is illuminated and, on 5 second intervals, a voice annunciation of ‘check airspeed” is presented via audio 450. Actuation of switch 420 will delay or cancel the voice annunciation.

Programming executing on MPU 200B monitors for a gear overspeed condition. If the landing gear is not in an up position and airspeed is above a maximum landing gear airspeed set point, as determined by data provided by the aircraft manufacturer, then warning light 410 is illuminated, display module 300B illuminates a gear message, and a voice annunciation of “gear overspeed” is presented via audio 450.

Computer 650, which may include a desktop, laptop, handheld or other computer, can be coupled to MPU 200B via connector cable 230. In one embodiment, cable 230 includes an RS232 serial cable and is selectable for communicating using port com1 or com2.

Programming executing on computer 650 communicates with MPU 200B and provides access to stored data, calibration functions and data writing functions. For example, computer 650 can read the serial number, version number or other data concerning MPU 200B, display module 300B and sensor module 100B. Computer 650 can adjust the volume level of alerts delivered via audio 450, greetings volume (including recitation of the volume level for voice alerts, training mode and software version), as well as read or write the following parameters and set points: cylinder temperature (high set point), bus voltage (low and high set point), oil pressure (low set point), vacuum (fail, low and high set points), carbon monoxide alert and warning levels, gear down speed set point, gear over-speed set point, accelerated stall speed, minimum pitot current set point, minimum fuel pump current set point and maximum airspeed (velocity never exceed, V_{NE} ) set point. In addition, computer 650 includes programming to specify or select and input table corresponding to gear lights, cabin door, baggage door, engine analyzer and other functions.

Furthermore, computer 650 includes programming to initiate, set or read calibrations for the fuel tank (full), airspeed, carbon monoxide (low and high levels), oil temperature range calibration (including bus voltage variance) and accelerometer sensor. Calibration of the present subject matter may be performed in a shop or in the aircraft.

Calibration of the accelerometer entails noting the output signal from the accelerometer while positioned in two different orientations. The accelerometer is positioned as it will be mounted in the aircraft and a first output signal is stored. A second output signal is stored when the accelerometer is positioned inverted. The combination of the first output signal and second output signal allows MPU 200B to calibrate the accelerometer.

Sensor module 100B includes pressure transducers and is coupled to MPU 200B by bus 240. For example, sensor module 100B interfaces with the aircraft pitot pressure, static pressure, vacuum and pressure altitude (for pressurized aircraft), the accelerometer (g-sensor) 130A and MPU 200B. Sensor module 100B includes pitot input 110A and static input 115A, coupled to the aircraft pitot line and static pressure line. One or more pressure transducers of sensor module 100B provides an electrical signal based on the pressures sensed at pitot input 100A and static input 115A. In one embodiment, the pressure transducer includes a silicone diaphragm solid-state device that is temperature compensated and having a range of +/−1.5 psi and a resolution of +/−2 knots. In a failure mode, the pressure transducer will generate a false “check airspeed” alert.

Inputs to sensor module 100B includes vacuum input 120A and ambient input 125A, coupled to the aircraft vacuum and ambient pressure system. For pressurized aircraft, ambient input 125A is coupled to a region external to the pressure vessel. Vacuum input 120A is coupled to the vacuum system at an open port or tee on a vacuum driven instrument. One or more pressure transducers of sensor module 100B provides an electrical signal based on the pressures sensed at vacuum input 120A and ambient input 125A. In one embodiment, the pressure transducer includes a silicone diaphragm solid-state device that is temperature compensated and having a range of +/−14.5 psi and a resolution of +/−2.5%. In a failure mode, the pressure transducer will produce a false vacuum alert. In one embodiment, the vacuum fail, vacuum low and vacuum high set points are set to 1.00, 3.00 and 6.00 in Hg, respectively.

Accelerometer 130A includes a microchip that generates an analog voltage when acceleration is detected along one axis. Accelerometer 130A has a range of +/−5 g's and has a resolution of 2 mg's. In a failure mode, accelerometer 130A will produce a false “check airspeed” alert.

Carbon monoxide sensor 135A is coupled to sensor module 100B. Carbon monoxide sensor is installed in a position to be exposed to cabin air and includes a solid state device that uses chromium titanium oxide as a detecting material. Sensor 135A has a range of 5−100 ppm and an accuracy of +/−3 ppm at 30 ppm and +/−5 ppm at 70 ppm. In a failure mode, sensor 135A will provide a signal to indicate an alert. MPU 200B executes programming to detect a failure of sensor 135A. If MPU 200B detects a failure of carbon monoxide sensor 135A, then a voice annunciation will present “carbon monoxide sensor failure” via audio 450 and the carbon monoxide alert is disabled. MPU 200B illuminates caution light 415 for carbon monoxide levels between 35 and 50 ppm and illuminates warning light 410 for carbon monoxide levels above 50 ppm. The time difference between illumination of caution light 415 and warning light 410 provides an indication of the rate of increase of carbon monoxide in the cabin. In one embodiment, a digital display in the cockpit provides a numerical value for measured carbon monoxide levels.

Calibration of carbon monoxide sensor 135A includes storing (in memory accessible to MPU 200B) the pulse counts generated by sensor 135A when exposed to an atmosphere known to have a carbon monoxide concentration of 0 ppm and when exposed to an atmosphere of 50 ppm. A linear relationship between the values of 0 ppm and 50 ppm allows extrapolation of counts for atmospheres having levels greater than 50 ppm.

In one embodiment, sensor 135A includes a solid state element sensitive to variations in humidity, temperature and altitude. At the time of system start up, and after sensor 135A has reached a stable operating temperature, a base line measure of counts is stored in memory accessible to MPU 200B. Programming executing on MPU 200B calculates an offset from the baseline to allow accurate measurements of elevated carbon monoxide levels.

In addition, a raw pulse count is determined at initial start up of the present system. The raw pulse count may be in the range of 0 to 1024 pulses per 100 mS from an analog-to-digital (A-to-D) counter. If the raw count range is less than 375 or greater than 725, then a voice annunciation message of “carbon monoxide failure” is presented via audio 450.

A heater provides a stable, warm temperature for sensor 135A. Heater failure is detected by programming executing on MPU 200B which changes the electrical power supplied to the heater by means of a switchable resistor divider network. Heater functionality is verified by a change in sensor 135A counts when the heater power is changed. In one embodiment, a properly functioning sensor 135 will generate a change of 80+/−50 counts when the heater power is changed. In one embodiment, sensor 135 will exhibit an increase in the count when the heater power is reduced.

In a high temperature, high humidity environment, sensor 135A clears itself as a function of power on time. Sensor 135A operates at a nominal temperature of 400° C. when powered. A carbon filter element of sensor 135A removes impurities at the elevated temperature. When sensor 135A is unpowered, the sensor absorbs moisture in a high humidity, warm temperature environment. Impurities remaining in the carbon filter interfere with accurate readings from sensor 135A. After continuously powering sensor 135A on for approximately 5 to 6 hours, impurities on the carbon filter element are baked out and sensor 135A again will provide accurate data. If the count rate drops below the start-up baseline count, then programming executing on MPU 200B will replace the start-up baseline with the new low level.

If the count is greater than 500, then sensor 135A calculates a new baseline level every two minutes and verifies heater functionality. If the count is between 450 and 500, then sensor 135A calculates a new baseline every 20 minutes.

If the airspeed is greater than 40 knots and the system performs a reboot, then sensor module 100B uses the last baseline value and disables the start-up baseline calculation.

Software

Processors in MPU 200B, display module 300B and sensor module 100B execute instructions to control the operation of the present subject matter.

An engine start routine is executed to determine whether the aircraft engine has properly started or is malfunctioning. The routine receives data from the oil pressure transducer, via input OIL PRES 570A, and the aircraft vacuum pressure system, via vacuum input 120A. The first pressure to reach 50% of its low or minimum set point will arm both annunciators for proper failure annunciation at engine start.

In addition, an airspeed indication, via inputs 110A and 115A, above the stall speed set point indicates the aircraft is in flight and activates gear annunciation and airspeed annunciations. In one embodiment, if either oil pressure or vacuum is above 50% of its minimum set point, then both are armed. Therefore, if oil pressure rises and vacuum does not, then the oil pressure will in turn, arm the vacuum and the vacuum warning will occur.

Annunciation Manipulation and Configuration

The message lights of display module 300B remain illuminated for as long as the alert is active.

Various conditions will give rise to voice annunciations not accompanied by illumination of an acknowledge switch message or display module message. In these cases, the voice alert is presented once upon alert initiation and if the alert condition were to be corrected and occur again, then a second voice annunciation would be provided. In one embodiment, an alert condition is signaled using acknowledge switch 400B. In one embodiment, an alert condition is signaled using both acknowledge switch 400B and display module 300B.

Notwithstanding the foregoing, for oil temperature alerts, the voice annunciation is repeated every 5 to 10 seconds (approximately) and warning light 410 remains illuminated. A single actuation of switch 420 will extend the voice annunciation repetition rate to once every 5 minutes. A double actuation of switch 420 will cancel future voice alerts as to oil temperature.

In addition, for airspeed alerts, the voice annunciation is repeated every 5 to 10 seconds (approximately) and warning light 410 remains illuminated. A single actuation of switch 420 will extend the voice annunciation repetition rate to once every 5 minutes. A double actuation of switch 420 will cancel future voice alerts as to airspeed at the V_{NE}.

Also, for engine analyzer alerts, audio 450 presents the alarm signal as provided by the analyzer. For example, when a parameter monitored by the analyzer is exceeded, the present subject matter will annunciate the alarm. The voice annunciation is repeated every 5 minutes (approximately) and warning light 410 remains illuminated. A double actuation of switch 420 will cancel future voice alerts as to the engine analyzer.

For cabin door alerts, the voice annunciation is repeated every 5 minutes (approximately) and caution light 415 remains illuminated. A single actuation of switch 420 will cause caution light 415 to extinguish for the duration of the 5 minutes and illuminate thereafter. A double actuation of switch 420 will cancel future alerts as to the cabin door ajar unless the cabin door is cycled. Cabin door position is determined by an airframe mounted microswitch.

For baggage or utility door alerts, the voice annunciation is repeated every 5 minutes (approximately) and caution light 415 remains illuminated. A single actuation of switch 420 will extend the voice annunciation repetition rate to once every 5 minutes and cause caution light 415 to extinguish for the duration of the 5 minutes and illuminated thereafter. A double actuation of switch 420 will cancel future voice alerts as to the baggage or utility door ajar. Door position is determined by an airframe mounted microswitch.

As to navigation, the GPS message alert may be illuminated for extended periods of time. As such, audio 450 does not provide an audible alert but rather the lighted message of display module 300B remains illuminated. In addition, the WPT alert has a rearming delay of 25 seconds. That is, following a WPT voice alert, a 25 second reset timer is started and the WPT alert will not activate again until the reset timer has completed its cycle.

Voice annunciations can be muted by the user. A single activation of switch 315 on display module 300A will silence all voice annunciations and save any further notifications in a queue. Stored notifications can be played audibly, via audio 450 by activating, or pressing, switch 315 once.

Upon a single activation of switch 315, the present system enters a mute mode and all voice annunciations are muted. Warning or caution conditions detected after the single activation continue to cause the appropriate light to be illuminated (either warning light 410 or caution light 415) however voice annunciations are not immediately presented via audio 450.

While in the mute mode, if switch 315 is again activated, then the present system returns to a normal mode and the voice annunciations are again presented via audio 450 upon detection. In addition, the stored contents of a queue are presented by voice annunciation via audio 450. For example, if a cabin door ajar condition is detected while in a mute mode, and the door remains ajar upon return to normal mode, then a voice annunciation will be presented.

Double clicking switch 315 will cause a voice annunciation to be repeated. If, as in the example above, the door is no longer ajar, then double clicking switch 315 will not cause the voice annunciation to be repeated. If the cabin door condition is no longer detected when the switch 315 is double clicked, then the door ajar annunciation will not be presented. To double click, the operator activates switch 315 twice in a period of approximately 2 or 3 seconds.

To reduce false or nuisance alarms, hysteresis is provided. In one embodiment, the hysteresis is 5% of the value established as a set point. For example, if an airspeed set point is established at 40 knots, then for the condition to be cleared, the airspeed has to be raised to 42 knots. Airspeeds below 42 knots will continue to generate an alert.

As to fuel level alarms, the software analyzes 1024 transducer voltage samples and averages those sample over a period of 100 seconds.

As to stall warnings, a 1.20 second delay is introduced to prevent false warnings due to buffeting and vane flutter.

As to landing gear warnings, the gear is given a 20 second period of time to transition from up to down or down to up. In addition, the present system provides approximately 5 second delay before annunciating up and down lights on simultaneous.

All alerts are provided as herein described in the order of activation. Flight critical annunciation, including stall warning, accelerated stall warning and V_{NE} warning, will take priority over all other annunciations. In other words, if a cabin door alert is being annunciated at a time when an accelerated stall is detected, the cabin door voice annunciation will be interrupted and the accelerated stall warning voice annunciation will be presented.

The bus voltage during certain phases of aircraft operations may drop harmlessly. For example, before take-off and after landing the engine RPM may not be continuously high enough to maintain the minimum bus voltage requirements. To prevent false low voltage alerts the present subject matter starts a timer for a 5 minute delay when the bus voltage drops below the low set point. If the bus voltage remains below the low set point after the time delay, the system will initiate the low voltage alert.

A self-test of the entire system is executed upon powering the system. A voice annunciation confirming satisfactory results of the self-test is provided via audio 450.

In addition, a watchdog continuous system test operates in the background and conducts self-checks. Also, carbon monoxide sensor 135A is self-tested every 20 minutes or 2 minutes, depending on the raw pulse count. For example, if the pulse count is less than 500, then the self-test is performed every 20 minutes and if the pulse count is greater than 500, then self-test is performed every 2 minutes. The self-test of sensor 135A entails adjusting the heater power level and monitoring for a change in count.

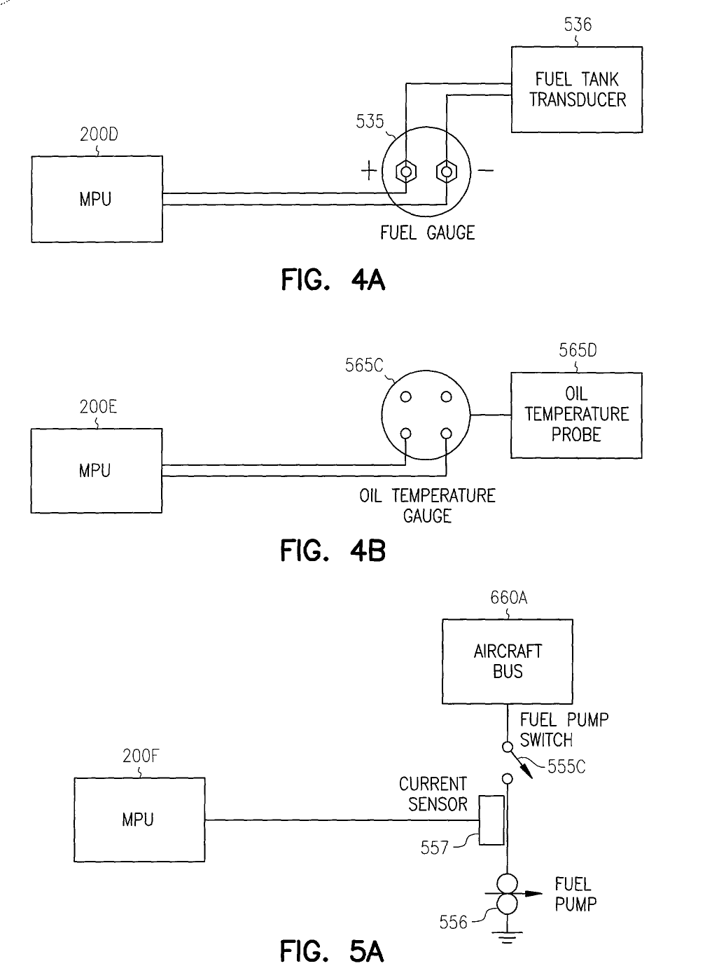

FIG. 3 illustrates a portion of the present subject matter. In the figure, MPU 200C is coupled to cylinder head temperature thermocouple 530B. Cylinder head temperature (CHT) thermocouple 530B provides an electrical voltage signal based on a measured temperature. CHT thermocouple 530B is illustrated as a ring J-type thermocouple and is sized for installation in lieu of a spark plug gasket in a particular cylinder.

In one embodiment, the junction temperature of the thermocouple wire with the aircraft wire within the wiring harness is measured. The junction temperature is measured with a thermistor and the thermistor is co-located at the junction point.

The cylinder temperature signal corresponds to a voltage signal input having a selectable range from 0 to 15 millivolts (mV) with a scale factor of 300° C.=4.5 v and with a gain of 300. Analog to digital accuracy is 10 bit, sample rate is 100 mS and latency is 100 mS.

Left fuel gauge 535C and right fuel gauge 535D are coupled to MPU 200C. For example, a fuel level transducer in the left fuel tank is coupled to left fuel gauge 535C and a parallel wire connection is established to MPU 200C. For both the left and right fuel gauge, the input signal from the fuel gauge is a DC voltage and is selectable in the range of 0-100 mV, 0-1 v, 0-14 v and 0-28 v with scale factors of gain equal to 50, 5, 0.32 and 0.16, respectively. Analog to digital accuracy is 10 bit, sample rate is 100 mS and latency is 100 mS.

Pitot heat switch 545B is the source for the pitot heat sensor input and is coupled to MPU 200C as illustrated in the figure. An input signal is received from a 0-20 A current sensor and from the pitot heat switch. The current sensor input signal is a 0-200 mV signal with a scale factor of gain 20. The pitot heat switch position sensor supplies 0-28 VDC.

Fuel pump switch 555B is the source for the fuel pump sensor input and is coupled to MPU 200C as illustrated in the figure. An input signal is received from a 0-20 A current sensor and from the fuel pump switch. The current sensor input signal is a 0-200 mV signal with a scale factor of gain 20. The fuel pump switch position sensor supplies 0-28 VDC.

Oil pressure sending unit 570B is the source for the engine oil pressure input and is coupled to MPU 200C as illustrated in the figure. The input signal is hardware selectable via dip switches and measures 0-100 psi. The input signal is selectable as a 0-100 mV or a 0-5 VDC signal with a scale factor of gain 50 or 1, respectively. Sending unit 570B includes a threaded portion that couples with a source of engine oil pressure.

Oil temperature gauge 565B is coupled to MPU 200C. An oil temperature transducer is coupled to oil temperature gauge 565B and a parallel wire connection is established to MPU 200C. In one embodiment, the oil temperature gauge includes an RTD element. The RTD element which drives the oil temperature gauge is also used to provide an electrical signal to MPU 200C. The present system does not interfere with an existing circuit of aircraft 12 to the extent of changing how the circuit operates, thus preserving the original certification of aircraft 12 issued by the Federal Aviation Administration (FAA).

Variations in aircraft supply bus voltage can affect the temperature indicated on the oil temperature gauge. To compensate for variations in bus voltage, a software routine is executed using the data received from the oil temperature transducer. A calibration harness is used to calibrate the temperature circuit.

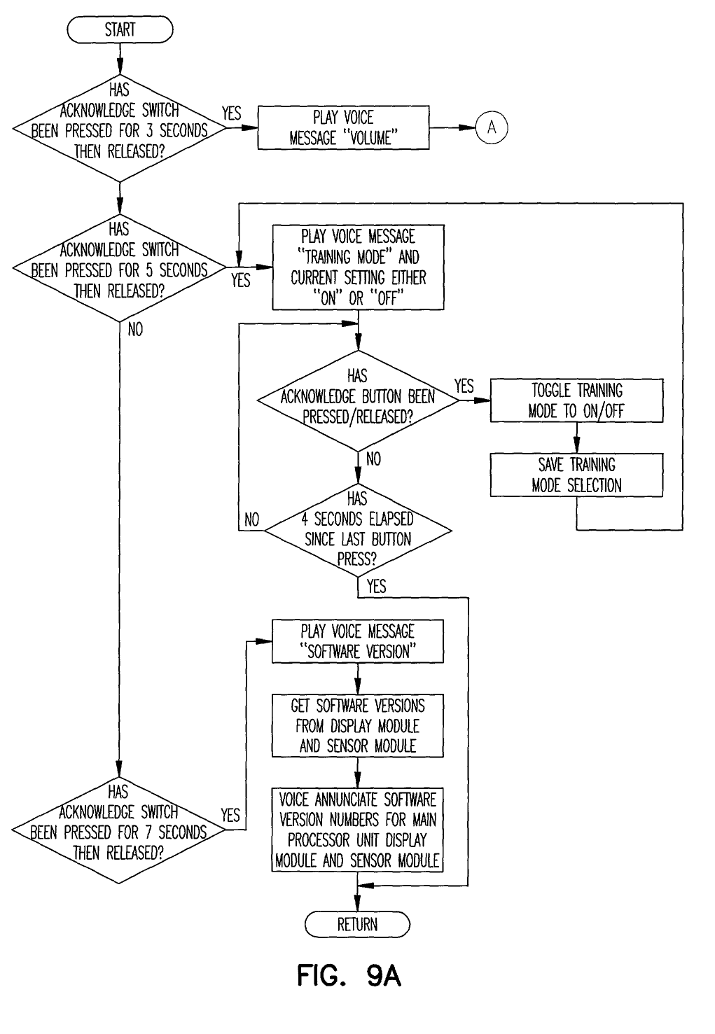

The oil temperature transducer output voltage varies with changes in the aircraft bus voltage. To calibrate for variations in bus voltage, a calibration harness is used temporarily. When connected, the calibration harness replaces the existing oil temperature transducer with a manually adjustable potentiometer. The oil temperature circuit can be modeled with the circuit shown in FIG. 6. Bus voltage at 660C is set to 14 VDC (or 28 VDC depending on the aircraft bus requirement). Potentiometer 610 is adjusted to cause aircraft oil temperature gauge 565D to indicate full scale deflection (FSD), or redline. The operator activates a switch coupled to MPU 200C to trigger the processor to receive and store bus voltage and the potentiometer voltage. In various embodiments, the switch coupled to MPU 200C includes a momentary contact switch, a soft switch on computer 650, or a key on the keyboard or mouse of computer 650.

Next, bus voltage at 660C is set to 12 VDC (or 24 VDC, as appropriate) and again, the potentiometer is manually adjusted to cause aircraft oil temperature gauge 565D to indicate FSD. The operator activates a switch to trigger the processor to gather bus voltage data and the potentiometer voltage. In various embodiments, the switch includes a momentary contact switch, a soft switch on computer 650, or a key on the keyboard or mouse of computer 650. Using these data points, the processor determines a set point for the alert as a function of bus voltage.

The set points define those conditions for which the pilot is to be warned. The processor executes instructions to determine the oil temperature set point based on the measured bus voltage. The software provides an alert set point that varies with changes in the bus voltage.

In one embodiment, a power supply is coupled to the aircraft bus and provides a supply voltage at 14 VDC. The potentiometer is adjusted to drive the oil temperature gauge to FSD and the potentiometer output voltage is measured and stored by the processor. Next, the 14 VDC supply is removed and the bus voltage is allowed to drift down to nominal battery voltage, approximately 12 VDC. Again, the potentiometer is adjusted to put the temperature gauge needle at FSD and the potentiometer voltage is measured and stored. Sample calibration data is as follows:

| gauge indication | bus voltage, VDC | RTD voltage, VDC |
|---|---|---|
| 100° F. | 14.0 | 0.913 |
| 100° F. | 12.0 | 0.783 |
| 200° F. | 14.0 | 1.024 |
| 200° F. | 12.0 | 0.878 |

In one particular aircraft, it has been observed that for temperature variations of approximately 5° F. in the range of 100° F., the RTD voltage varies by approximately 0.13 VDC. For temperature variations of approximately 5° F. in the range of 200° F., the RTD voltage varies by approximately 0.146 VDC.

The measured voltages can be modeled by a non-linear equation and the processor of MPU 200B calculates the proper voltage levels for which to signal an alert to the pilot.

Returning to FIG. 3, gear up light 585B and gear down light 590B provide electrical connections for coupling landing gear data to MPU 200C.

Aircraft navigation data, symbolized by block 502B, is provided to MPU 200C. Waypoint data is provided on line 510B. For example, when an on-board GPS receiver indicates a waypoint passage alert, an active low signal is generated by the GPS receiver on line 510B. The waypoint passage is annunciated as described herein. In addition, when a VOR/LOC is selected for the primary navigation, an active low is generated by the GPS receiver on line 515B and when the GPS receiver is selected for primary navigation, an active low is generated by the GPS receiver on line 520B. When the primary navigation system issues a message, a active low signal is generated on line 525B.

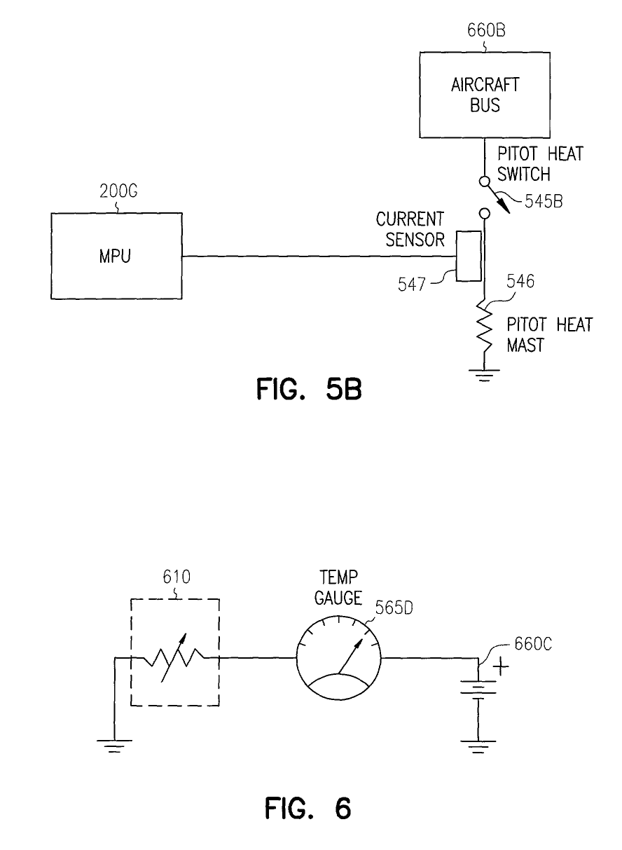

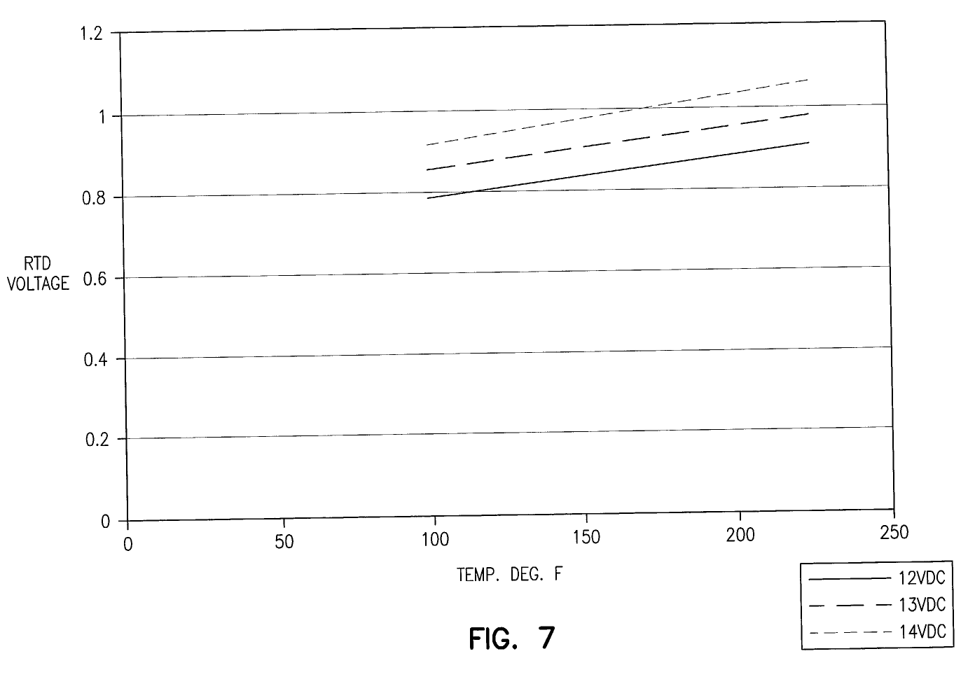

FIG. 4A illustrates the electrical connections between MPU 200D, fuel gauge 535 and fuel tank transducer 536. The functionality of fuel gauge 535 is not affected by MPU 200D.

FIG. 4B illustrates the electrical connections between MPU 200E, oil temperature gauge 565C and oil temperature probe 565D. The functionality of oil temperature gauge 535C is not affected by MPU 200D.

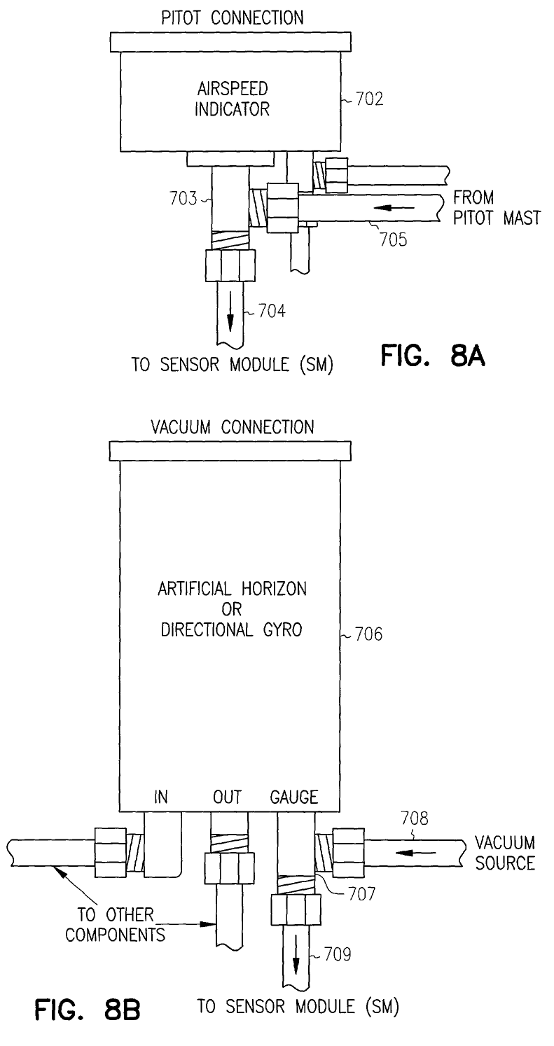

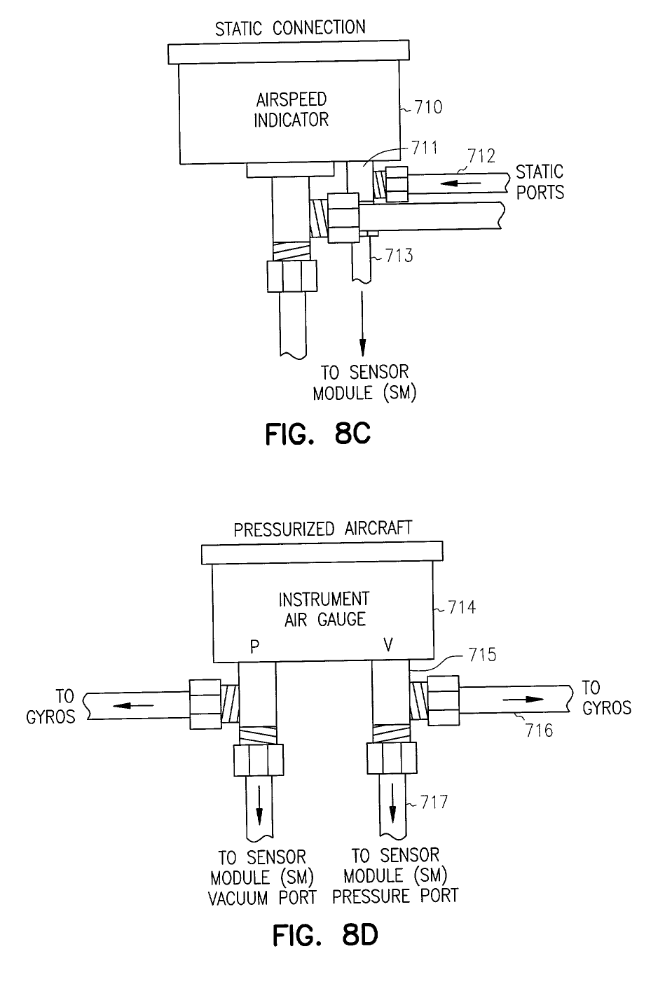

FIG. 5A illustrates current sensor 557 adapted to sense current flow between fuel pump switch 555C and fuel pump 556 as supplied by aircraft bus 660A. Current sensor 557 provides a signal to MPU 200F indicative of current in fuel pump 556 without affecting the operation of the fuel pump system.

FIG. 5B illustrates current sensor 547 adapted to sense current flow between pitot heat switch 545B and pitot heat mast 546 as supplied by aircraft bus 660B. Current sensor 547 provides a signal to MPU 200G indicative of current in pitot heat mast 546 without affecting the operation of the pitot heat system.

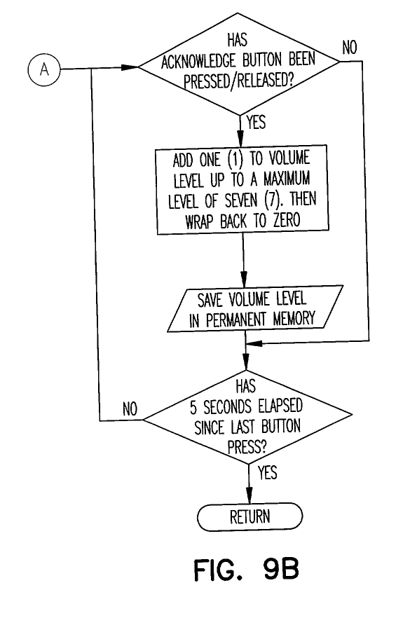

FIG. 7 graphically illustrates measured data corresponding to oil temperature RTD voltage as a function of temperature for output bus voltages at 12.0, 13.0 and 14.0 VDC. The data lines of the graph have different slopes with the lines diverging at higher temperatures. A best fit calculation is performed by software of the present subject matter to determine the calibrated temperature at different bus voltage levels.

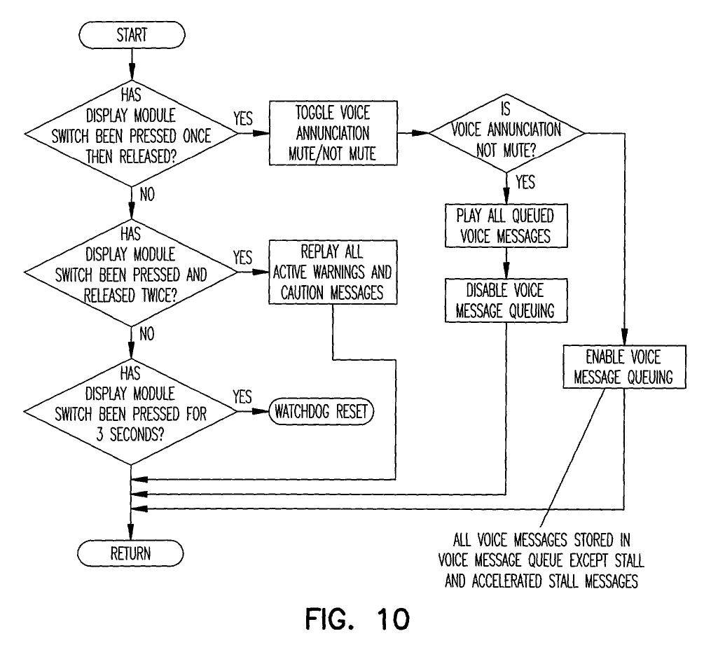

FIGS. 8A, 8B, 8C and 8D illustrate air line connections to various instruments. FIG. 8A illustrates airspeed indicator 702 coupled to sensor module 100B by line 704 and to a pitot mast by line 705 via tee connector 703. FIG. 8B illustrates artificial horizon or directional gyroscope 706 coupled to sensor module 100B by line 709 and to a vacuum source by line 708 via tee connector 707. FIG. 8C illustrates airspeed indicator 710 coupled to sensor module 100B by line 713 and to a static port by line 712 via tee connector 711. In one embodiment, static port is coupled to sensor module 100B by way of a vertical speed indicator (VSI) or other static port instrument. FIG. 8D illustrates an installation in a pressurized aircraft having vacuum gauge 714 coupled to sensor module 100B by line 717 and to pressure dump line or gyros 716 via tee connector 715. Line 717 is coupled to an ambient air source external to the pressurized cabin.

Annunciated Checklist

In one embodiment, a checklist of procedures is presented via audio 450. Each checklist item is presented via voice annunciation. A user operable switch will cause MPU 200B to annunciate the next item on the checklist. In one embodiment, the user operable switch is switch 420. In one embodiment, the user operable switch is switch 315. In one embodiment, the checklist items are annunciated in sequential order with each item separated from the last by a predetermined time delay.

The checklist may relate to procedures to be executed by airmen in an emergency situation. For example, an emergency engine out procedure is performed when the present subject matter determines that the airspeed is greater than a stall speed and within a predetermined period of time, the vacuum, engine oil pressure and bus voltage indicate a drop, then the present system provides an alert to signal an engine failure. In one embodiment, the predetermined time is approximately ten seconds in duration. In one embodiment, an engine failure alert includes illuminating warning light 410, voice annunciating “engine out, left” or “engine out, right” via audio 450, and illuminating a message “ENGINE OUT—L” or “ENGINE OUT—R” on display module 300B. Following the voice annunciation signaling an engine outage, the present system then presents the engine out procedures for that particular aircraft.

Consider an example with a left engine failure immediately after take-off. In this case, the engine out procedure calls for application of opposite side rudder and retract gear if the gear is down, feathering the dead engine propeller followed by other procedures. Main processor unit 200B indicates that the airspeed is greater than 40 knot stall speed and that within a ten second period of time, the left engine has lost vacuum, the engine oil pressure has fallen and the bus voltage has dropped. Main processor unit 200B illuminates warning light 410, voice annunciates “engine out, left” and illuminates message “ENGINE OUT—L” on display module 300B. In one embodiment, switch 410 is used to transition to the checklist annunciation routine. In one embodiment, MPU 200B automatically transitions to the checklist annunciation routine. Main processor unit 200B presents voice annunciation “apply right rudder” via audio 450. Upon application of right rudder, the pilot is instructed to activate switch 410. Activation of switch 410 causes MPU 200B to present the next voice annunciation. If data accessible to MPU 200B indicates that the landing gear is in the down position, then, the next voice annunciation includes “retract landing gear” presented via audio 450. If data accessible to MPU 200B indicates that the landing gear is in the up position, then, the next voice annunciation includes “feather left engine” presented via audio 450. Subsequent procedures are presented via voice annunciation in an order as determined by stored data provided by the aircraft manufacturer and the conditions detected by MPU 200B.

As another example, in one embodiment, a landing gear manual extension procedure is presented to the pilot via audio 450 in the event of a landing gear malfunction as determined by MPU 200B.

Double clicking switch 315 will cause the present checklist item to be repeated aloud via audio 450.

Self-Diagnostics

The present subject matter includes programming to execute one or more self-diagnostic routines as noted below.

If carbon monoxide sensor 135A indicates an abnormal condition during a self-test, an annunciated message such as “carbon monoxide sensor failure” is presented via audio 450. Additional explanatory information can also be provided by audio 450.

If carbon monoxide sensor 135A successfully passes a self-test, then an annunciated message such as “carbon monoxide sensor ready” is presented via audio 450. Notification of successful testing can occur anytime after a carbon monoxide sensor failure message.

If accelerometer 130A indicates an abnormal self-test, an annunciated message such as “please calibrate g sensor” is presented via audio 450. Additional explanatory information, such as circuit breaker identification and technical support information, can also be provided by audio 450.

If the present system detects a communication failure between MPU 200B and sensor module 100B, an annunciated message such as “system failure” is presented via audio 450. Additional explanatory information can also be provided by audio 450.

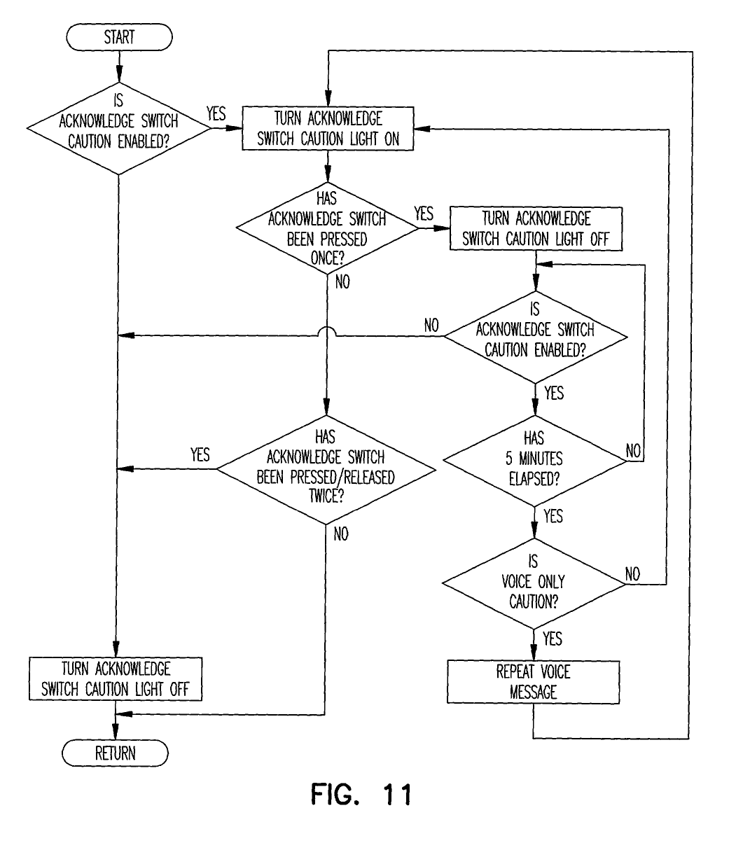

FIG. 9 illustrates a flow chart for receiving information from the acknowledge switch. In the figure, the acknowledge switch controls the volume control, training mode and provides voice annunciation of software versions.

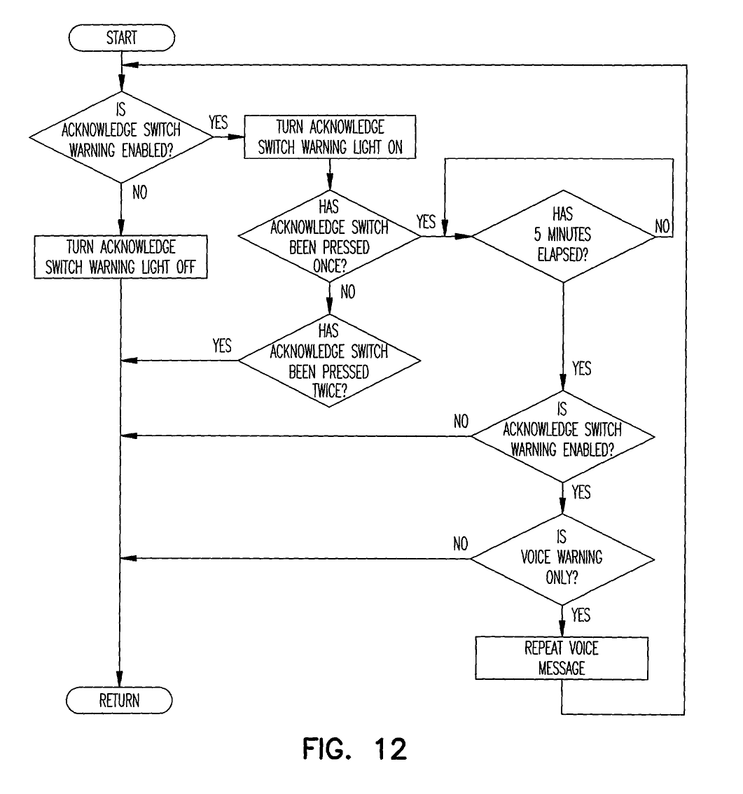

FIG. 10 illustrates a flow chart for receiving pilot selections using the display module switch. The display module switch permits control of voice annunciation, replay of active messages and re-boots MPU 200B.

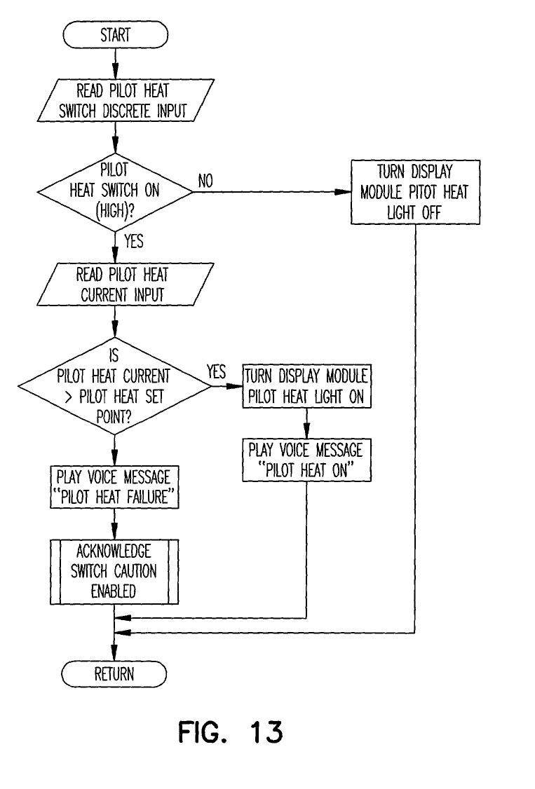

FIG. 11 illustrates a flow chart for a method based on actuation of the acknowledge switch. The method executed depends on the number of times the acknowledge switch has been pushed and whether a caution message is being alerted.

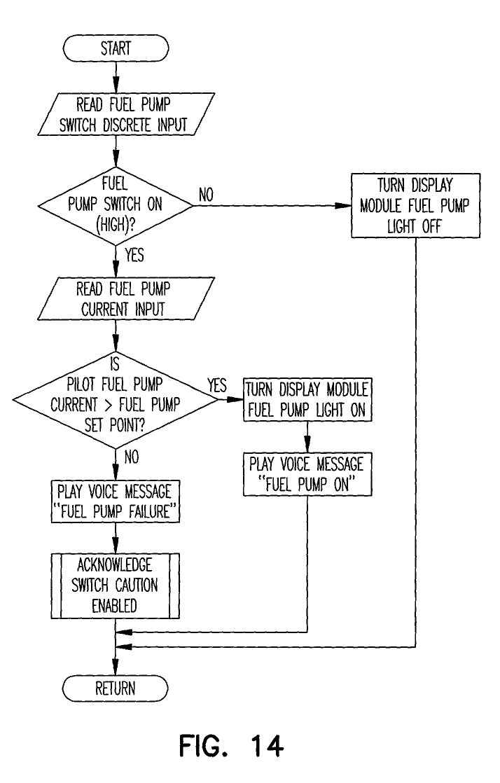

FIG. 12 illustrates a flow chart for a method based on actuation of the acknowledge switch. The method executed depends on the number of times the acknowledge switch has been pushed and whether a warning message is being alerted.

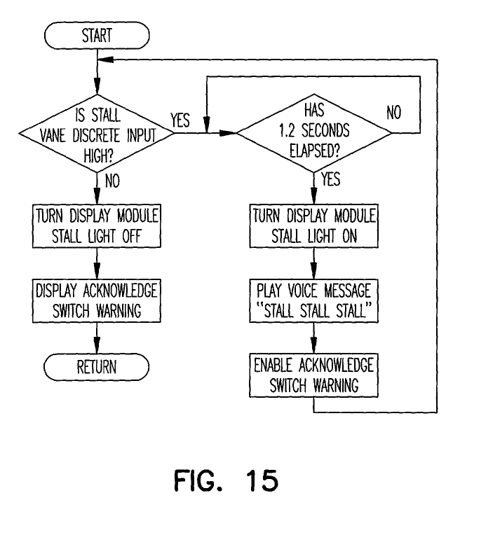

FIG. 13 illustrates a flow chart for a method based on monitoring the pitot heat sensor. The present subject matter determines if the pitot heat current is within predetermined limits.

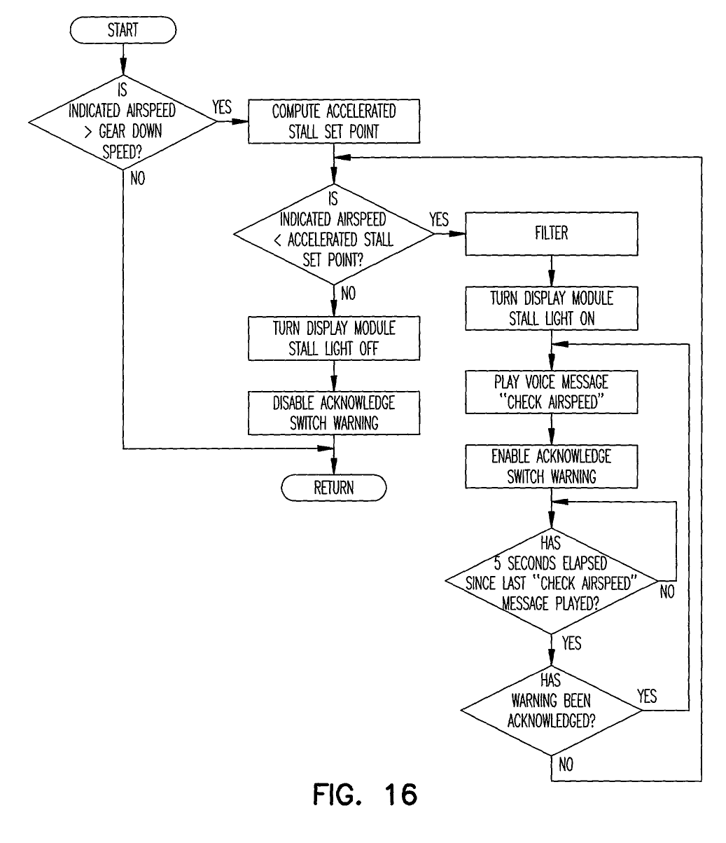

FIG. 14 illustrates a flow chart for a method based on monitoring the fuel pump sensor. The present subject matter determines if the fuel pump current is within predetermined limits.

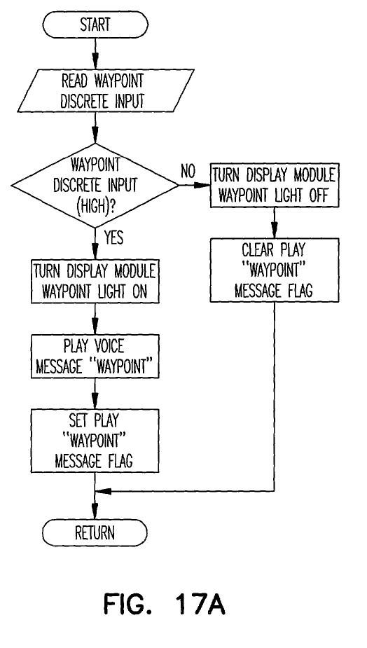

FIG. 15 illustrates a flow chart for a method based on the stall warning vane switch. A warning message is presented if a stall is threatened.

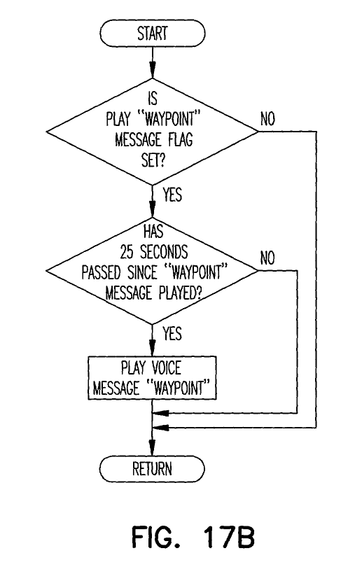

FIG. 16 illustrates a flow chart for a method based on detecting a threatened accelerated stall. The method includes calculating an accelerated stall set point.

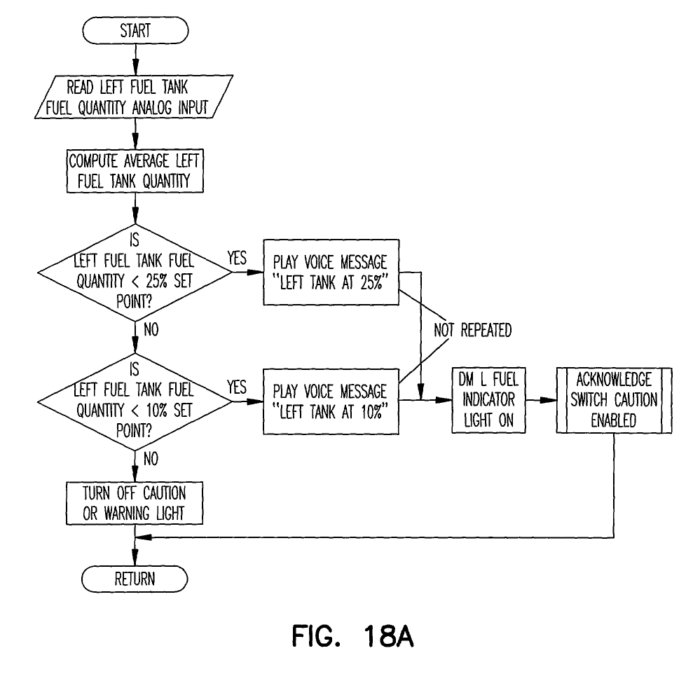

FIGS. 17A and 17B illustrate flow charts for a method based on alerting for a waypoint. The methods include annunciating depending on the status of a waypoint flag.

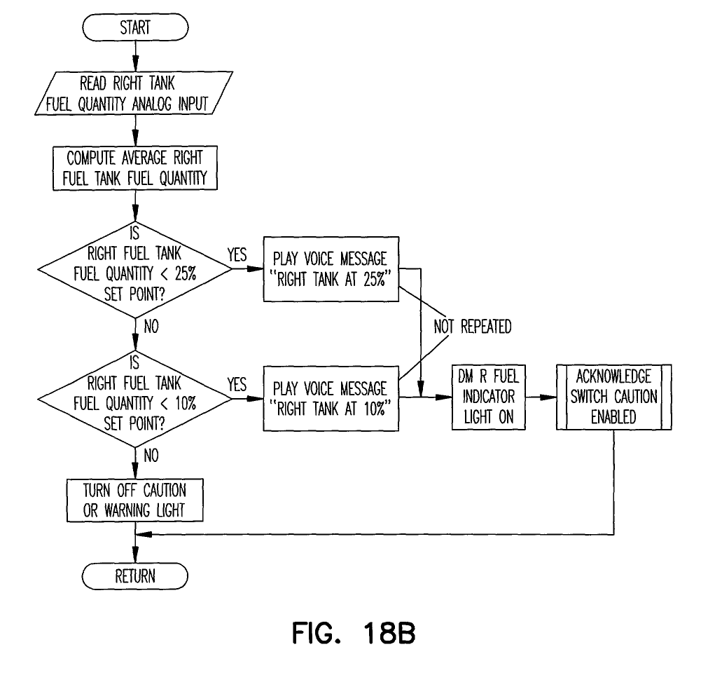

FIGS. 18A and 18B illustrate flow charts for methods based on fuel quantity indications. In FIGS. 18A and 18B, the fuel quantity remaining in the left fuel tank and right fuel tank, respectively, can trigger a caution alert.

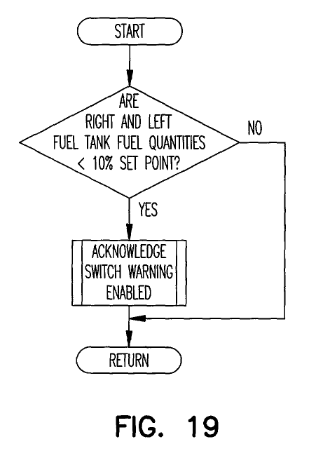

FIG. 19 illustrates a flow chart for a method based on remaining fuel in a tank. For sufficiently low fuel quantities, a warning alert is generated.

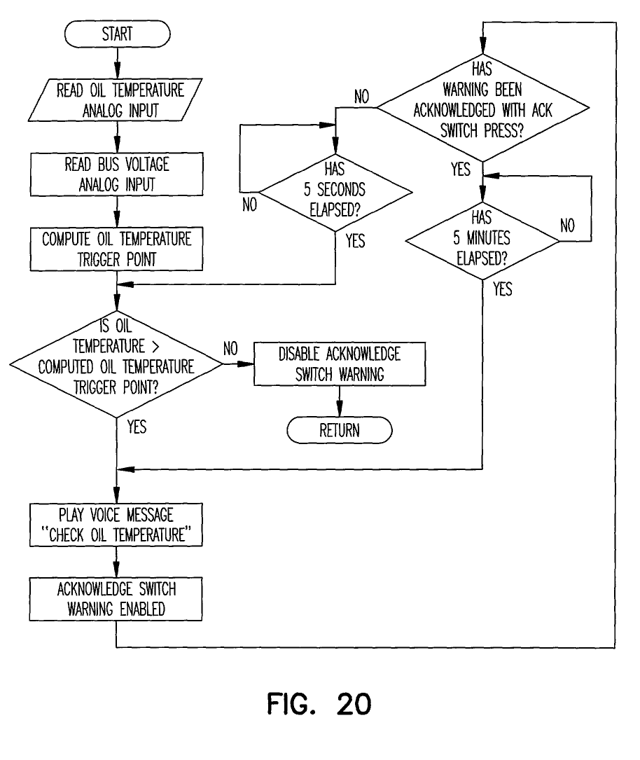

FIG. 20 illustrates a flow chart for a method based on a measured oil temperature. The oil temperature alert set point is based on the aircraft bus voltage.

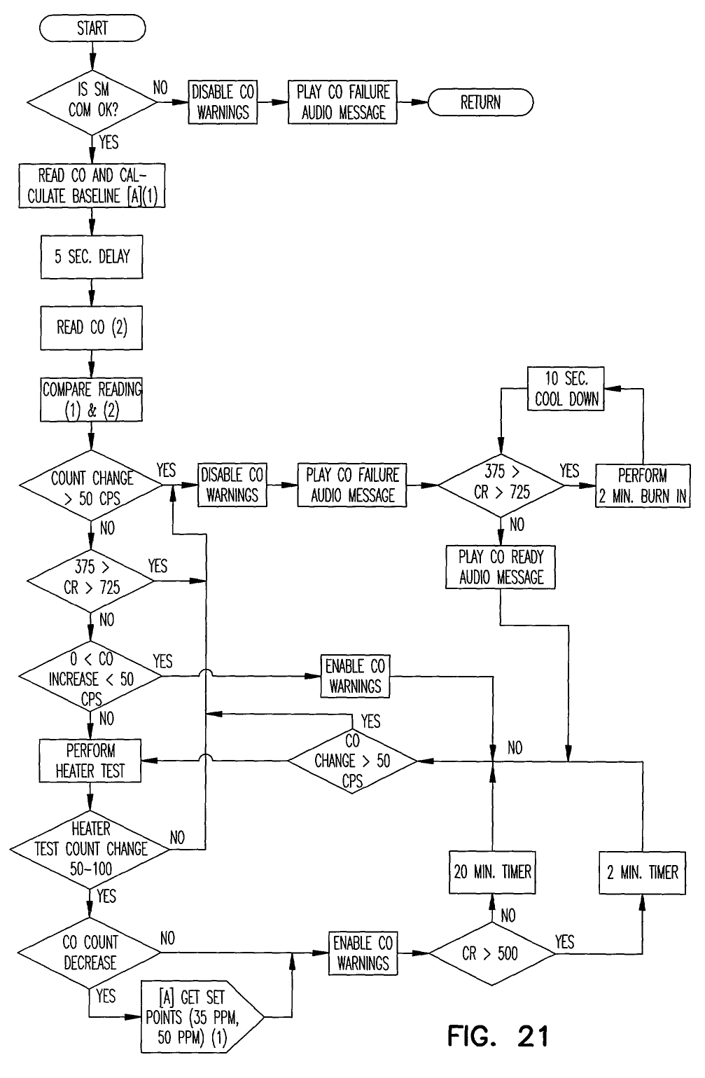

FIG. 21 illustrates a flow chart for a method based on carbon monoxide levels detected in the aircraft cabin. For detected levels of carbon monoxide, a warning alert is issued with voice annunciation.

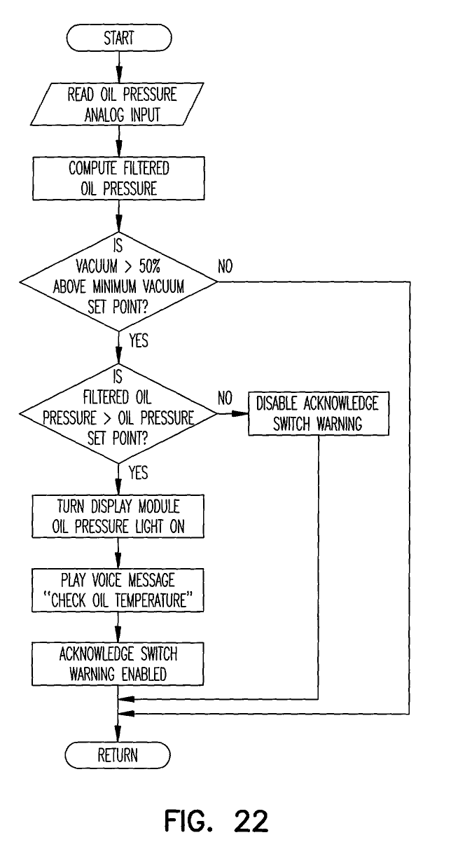

FIG. 22 illustrates a flow chart for a method based on detected oil pressure levels. For oil pressures below a predetermined level, a warning alert is issued with voice annunciation.

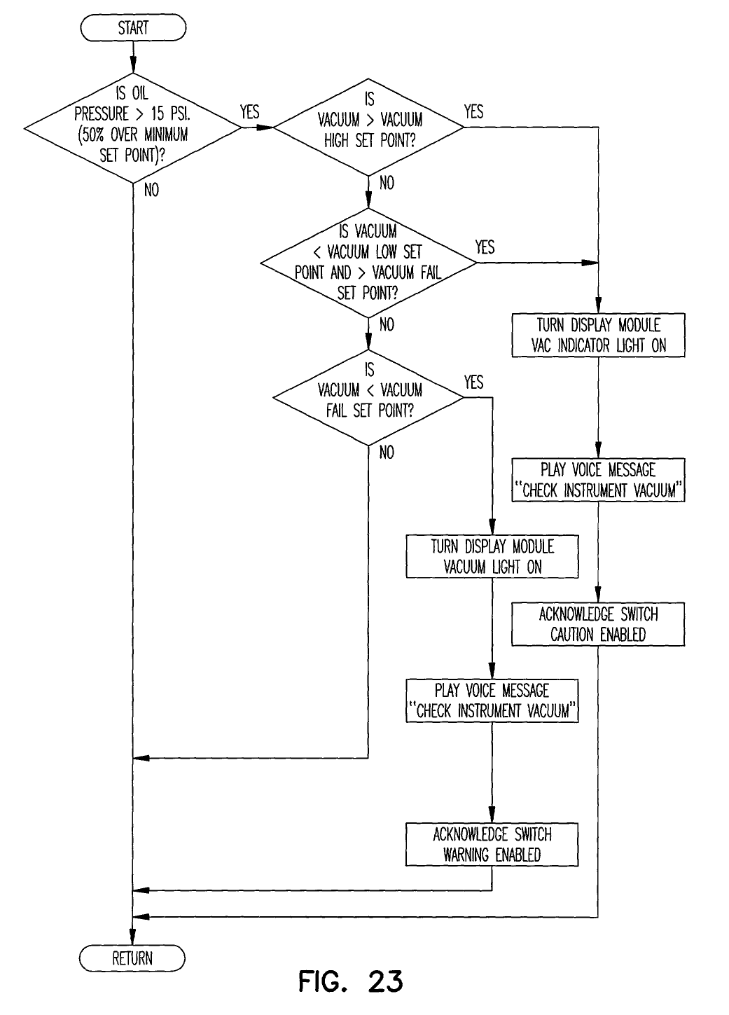

FIG. 23 illustrates a flow chart for a method based on detected oil pressure levels and vacuum levels. For oil pressures and vacuum levels below a predetermined level, a warning alert message is annunciated.

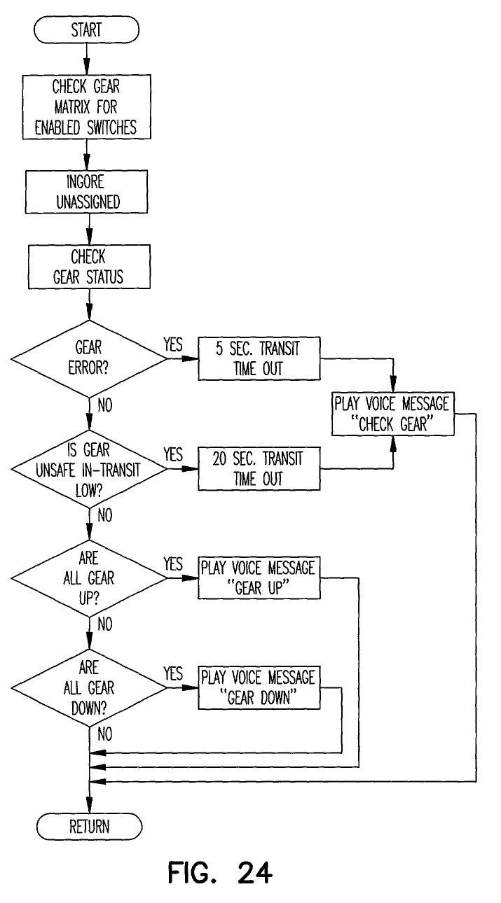

FIG. 24 illustrates a flow chart for a method based on landing gear position sensor switches. Audible messages are presented to the pilot depending on the switch positions.

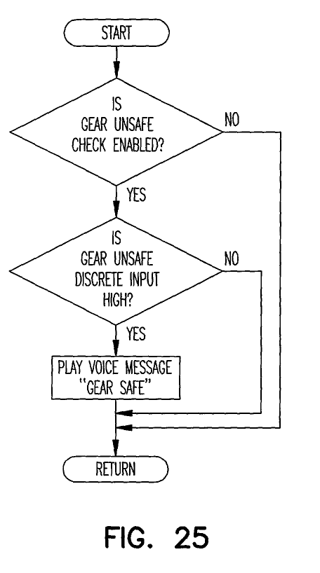

FIG. 25 illustrates a flow chart for a method based on landing gear position sensor switches.

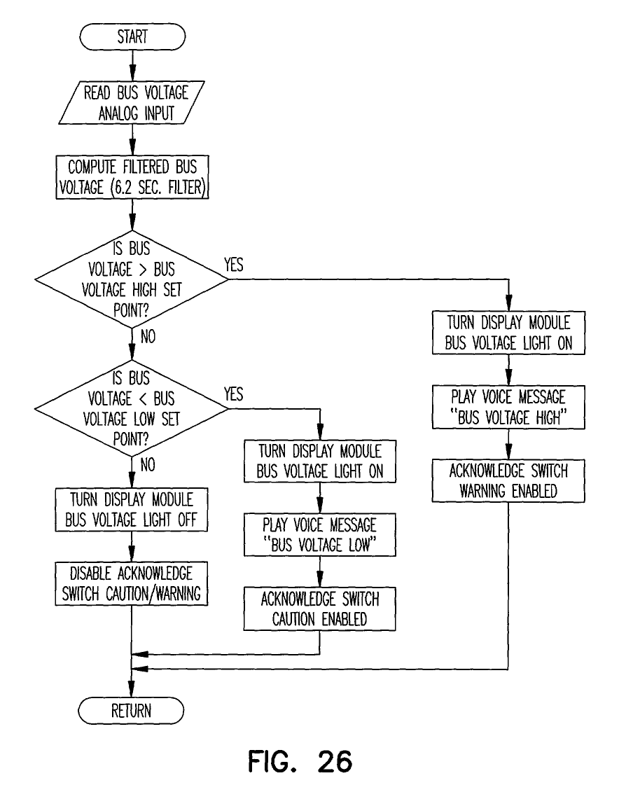

FIG. 26 illustrates a flow chart for a method based on aircraft bus voltages. Caution and warning alerts are issued based on measured voltage levels.

Alternative Embodiments

Variations of the above embodiments are also contemplated, including the following:

In one embodiment, if messages appearing on display module 300B cycle in a rotating pattern, communications between MPU 200B and display module 300B have likely failed. An annunciator message, including data as to possible connection failures, is presented via audio 450.

In one embodiment, different messages, different colors and different notification systems can be utilized. For example, in one embodiment, one or more turbine engines power the aircraft and annunciated conditions and parameters include those selected from the following: ignition; beta; chip detector; inlet heat; fuel selector; fuel bypass; generator; fuel pressure; start (start cycle); torque; ITT (inlet turbine temperature); turbine RPM; fan rpm; N1, N2; rotor RPM; anti-icing; de-ice; function of navigation and anti-collision lights; auxiliary fuel tanks; hydraulic pressure; fuel filter; and fuel heaters. In addition to those conditions and parameters presented earlier, for piston powered aircraft, the following may be included for annunciation: TIT (turbine inlet temperature); flap setting; anti-icing; de-ice; function of navigation and anti-collision lights; auxiliary fuel tanks. Furthermore, aircraft engaged in agricultural or fire fighting operations may include annunciation of conditions and parameters related to hopper level and spray pressure. Other conditions and parameters can be monitored, including avionics messages, trim position or trim failures and navigation signal loss. Those conditions and parameters presented herein are not to be taken in a limiting sense but are presented for example only.

In one embodiment, a voice only annunciation is provided and no lights or visual messages are presented.

In one embodiment, the present subject matter monitors flight, engine, and navigation systems for a multi-engine aircraft.

In one embodiment, acknowledge switch 400A and display 300A are installed within a single housing.

In one embodiment, acknowledge switch 400A includes a user-operable switch in a first location and a visual display portion in a second location. In one embodiment, acknowledge switch 400A includes a first and second panel-mounted light and a yoke-mounted or panel-mounted switch.

In one embodiment, switch 315 is not included and acknowledge switch 400A performs functions described herein as being performed by switch 315.

In one embodiment, switch 315 and acknowledge switch 400A include a soft switch, a touch-sensitive switch or other user operable switch. The switches may be momentary contact or latching type contact switches.

In one embodiment, display module 300A and acknowledge switch 400A include plastic housings and are adapted to receive mounting hardware for installation in, or on, an instrument panel of aircraft 12.

In one embodiment, a different warning light, caution light and display light color is used. In one embodiment, set point levels and timer durations and delay durations are user or operator selectable.

In one embodiment, programming described herein is executed on a processor of MPU 200B, a processor of display module 300B or sensor module 100B.

In addition to J-type or K-type thermocouples and RTDs, other types of temperature sensors are also contemplated. For example, in one embodiment, a temperature probe is adapted for threading into a tapped bore of a engine cylinder or other component. In one embodiment, an exhaust gas temperature sensor is used. A J-type thermocouple is one fabricated of iron and constantan and K-type thermocouple is one fabricated of chromel and alumel.

In one embodiment, engine oil temperature is monitored by an alternative configuration. For example, in one embodiment, the processor is coupled to the bus voltage and the voltage at the potentiometer and the processor receives and stores potentiometer voltages at different bus voltages for selected gauge indications. The calibration routine in the software then establishes set points.

In one embodiment, the calibration routine in the software establishes a best-fit curve, based on selected measured values, to determine set points. In one embodiment, the software accesses a stored look-up table of data to determine set points. In one embodiment, the software interpolates data between measured values to determine set points.

In one embodiment, the processor regulates the bus voltage and the operator adjusts a potentiometer to set the gauge to FSD. In one embodiment, the operator activates a button to cause the processor to receive and store the bus voltage and the potentiometer voltage. In one embodiment, potentiometer voltages are measured at bus voltages set to 12.0 VDC and 14.0 VDC. In one embodiment, potentiometer voltages are measured at bus voltages set to value less than 12.0 VDC and greater than 14.0 VDC.

In one embodiment, the relationship between sensor output voltage and bus voltage is approximated by a stored non-linear equation. In one embodiment, the relationship between sensor output voltage and bus voltage is approximated by a stored linear equation.

In one embodiment, digital logic levels different than those described herein are used.

In one embodiment, monitoring of a parameter or condition is suspended temporarily for conditions outside of a predetermined range.

In one embodiment, the carbon monoxide sensor includes a solid chemical sensor element.

### Conclusion

The above description is intended to be illustrative, and not restrictive. Many other embodiments will be apparent to those of skill in the art upon reviewing the above description.

What is claimed is:

1. A system comprising:
input means adapted for coupling to a plurality of aircraft systems of an aircraft and for generating one or more signals based on measured parameters;
processor means coupled to the input means and adapted to execute programming to compare one or more measured parameter with stored data;
a first message display means coupled to the processor for signaling existence of a potential hazard condition based on a signal received from the processor;
a second message display means coupled to the processor for signaling a system classification of the potential hazard condition;
an audio annunciation means coupled to the processor and adapted to present a voice message based on the potential hazard condition; and
a user operable switch means coupled to the processor and adapted to control the first message display means.

2. The system of claim 1 wherein the second message display means is adapted to present messages in a first, second and third color.

3. The system of claim 3 wherein the first color is green, the second color is amber, and the third color is red.

4. The system of claim 1 wherein the user operable switch means is adapted to control the audio annunciation means.

5. The system of claim 1 wherein the input means includes a pressure transducer.

6. The system of claim 1 wherein the input means includes an accelerometer.

7. The system of claim 1 wherein the input means includes a switch.

8. The system of claim 1 wherein the input means includes a temperature sensor.

9. The system of claim 1 wherein the first message display means includes a first light and a second light.

10. The system of claim 9 wherein the first light is red and the second light is amber.

11. The system of claim 1 further comprising an annunciator housing and wherein the first message display means and the user operable switch means are contained therein.

12. A system comprising:
an oil temperature sensor adapted for providing an output signal based on an aircraft engine oil temperature;
a processor coupled to the oil temperature sensor and a power supply of the aircraft wherein the processor executes instructions to determine engine oil temperature based on the output signal and a voltage level of the power supply and to generate a warning signal based on an engine oil temperature above a predetermined value;
a warning light coupled to the processor and adapted to indicate a warning upon receipt of the warning signal;
an audio driver coupled to the processor and adapted to provide voice annunciation upon receipt of the warning signal; and
a manual switch coupled to the processor and adapted to control the voice annunciation.

13. The system of claim 12 further comprising an oil temperature gauge coupled to the oil temperature sensor.

14. The system of claim 12 wherein the manual switch includes a momentary contact switch.

15. The system of claim 12 further comprising a connector coupled to the processor and adapted to connect with a calibration sensor.

16. The system of claim 12 further comprising a connector coupled to the processor and adapted to connect with a computer.

17. The system of claim 12 wherein the processor is adapted to execute instructions including accessing a look-up table.

18. A method comprising:
receiving a temperature signal from an engine oil temperature transducer;
illuminating a first warning light and generating a voice annunciation if the temperature signal corresponds to a temperature above a stored value; and
muting the voice annunciation upon receiving a cancellation signal from a user operable switch.

19. The method of claim 18 further comprising illuminating a second warning light if the temperature signal is above the stored value.

20. The method of claim 18 wherein generating a voice annunciation includes generating a series of repeated messages.

21. The method of claim 18 further comprising:
receiving a first peak signal corresponding to a predetermined engine oil temperature at a first bus voltage;
receiving a second peak signal corresponding to the predetermined engine oil temperature at a second bus voltage; and
generating a compensated temperature signal based on the first peak signal, the first bus voltage and the second peak signal and the second bus voltage; and
wherein illuminating the first warning light and generating the voice annunciation if the temperature signal corresponds to a temperature above a stored value includes illuminating the first warning light and generating the audible warning if the compensated temperature signal corresponds to a temperature above the stored value.
